(19) United States
(12) Patent Application Publication
(10) Pub. No.: US 2019/0118016 A1
(43) Pub. Date: Apr. 25, 2019

(54) MODULAR FIRE TRAINING SIMULATOR

(71) Applicant: LION GROUP, INC., Dayton, OH (US)

(72) Inventors: Constantinus Adrianus Marie SEVERIJNS, Baarle-Nassau (NL); Franciscus Josephus Anna JANSEN, Weedle (BE)

(73) Assignee: LION GROUP, INC., Dayton, OH (US)

(21) Appl. No.: 16/093,756

(22) PCT Filed: Apr. 14, 2017
(86) PCT No.: PCT/US2017/027627

§ 371 Date: Oct. 15, 2018

Related U.S. Application Data
(60) Provisional application No. 62/323,311, filed on Apr. 15, 2016.

(51) Int. Cl. A62C 99/00; G09B 9/00

(52) U.S. Cl. CPC A62C 99/0081; G09B 9/00

(57) ABSTRACT

A training system including a floor structure and a utility distribution system generally positioned in or below the floor structure. The utility distribution system includes a plurality of connection locations spaced about the floor structure. The system further includes a utility connection box removably fluidly connectable to the utility distribution system at each of the plurality of connection locations. The utility connection box is removably fluidly connectable to an external line or device to thereby fluidly connect the external line or device to the utility distribution system.

This application claims priority to U.S. Provisional Patent Application Ser. No. 62/323,311, filed on Apr. 15, 2016, the entire contents of which are hereby incorporated by reference.

This application relates generally to fire training simulators, and more particularly modular fire training simulators that can be modified to change the fire training scenarios presented by the simulator.

### BACKGROUND

Fire training simulators are used for training firefighters, first responders and others in procedures and methods for fighting fires and using firefighting equipment. Fire training simulators are generally designed to mimic commonly-encountered structures, such as an interior room of a dwelling, business or the like. These fire training simulators generally incorporate one or more props to enhance the accuracy of the setting.

### SUMMARY

In one embodiment, the invention is a training system including a floor structure and a utility distribution system generally positioned in or below the floor structure. The utility distribution system includes a plurality of connection locations spaced about the floor structure. The system further includes a utility connection box removably fluidly connectable to the utility distribution system at each of the plurality of connection locations. The utility connection box is removably fluidly connectable to an external line or device to thereby fluidly connect the external line or device to the utility distribution system.

### BRIEF DESCRIPTION OF THE DRAWINGS

FIG. 1 is a perspective view of one embodiment of a fire training simulator with certain exterior wall panels, roof panels and floor panels removed;

FIG. 2 is a perspective view of an interior of another embodiment of a simulator with the roof and an exterior wall removed;

FIG. 3 is a perspective view of another embodiment of a simulator with the roof, an exterior wall and portion of another exterior wall removed;

FIG. 4 is a top view of another arrangement of the simulator of FIG. 1;

FIG. 5 is a top view of another arrangement of the simulator of FIG. 1;

FIG. 6 is a top view of yet another arrangement of the simulator of FIG. 1;

FIG. 7 is a top view of a frame of a floor of the simulator of FIG. 1;

FIG. 8 is a perspective view of a portion of the frame of FIG. 7, with a utility distribution system incorporated therein;

FIG. 9 is a side view of a corner casting of the floor frame of FIG. 7;

FIG. 10 is a bottom view of the corner casting of FIG. 9;

FIG. 11 is a front view of a cross beam of the floor frame of FIG. 7;

FIG. 12 is a top view of the cross beam of FIG. 11, shown in conjunction with a pair of outer beams;

FIG. 13 is a front view of another embodiment of a cross beam of the floor frame of FIG. 7;

FIG. 14 is a perspective view of a roof frame of the simulator of FIG. 1;

FIG. 15 is a front view of a corner casting of the roof frame of FIG. 14;

FIG. 16 is a top view of the corner casting of FIG. 15;

FIG. 17 is a bottom perspective view of a roof panel of the simulator of FIG. 1;

FIG. 18 is a front perspective view of a wall panel of the simulator, with a connector coupled thereto of FIG. 1;

FIG. 19 is a front view of the wall panel and connector of FIG. 18;

FIG. 20 is an end view of the wall panel and connector of FIG. 18;

FIG. 21 is a side cross section of the wall panel of FIG. 18;

FIG. 22 is a front perspective view of the connector of FIG. 18;

FIG. 23 is a side view of the connector of FIG. 22;

FIG. 24 is a front view of the connector of FIG. 22;

FIG. 25 is a detail side view of a tab of the connector of FIG. 22;

FIG. 26 is a front perspective view of a simulator including two structures arranged side-by-side;

FIG. 27 is a front perspective view of a simulator including an two structures arranged side-by-side and another structure stacked on top of one of the structures;

FIG. 28 is a schematic illustration of a utility distribution system positioned in the floor of a simulator;

FIG. 29 is another schematic illustration of a fuel distribution system positioned in the floor of a simulator;

FIG. 30 is a top schematic view of a connection location in the floor of a simulator, showing parts of the distribution systems and various connections;

FIG. 31 is a side schematic view of the connection location of FIG. 30;

FIG. 32 is a schematic side view of the connection location of FIG. 31, with a connection box coupled thereto;

FIG. 33 is a front perspective view of a connection box;

FIG. 34 is a front perspective view of the connection box of FIG. 33 with the cover removed;

FIG. 35 is a cross-section of the connection box of FIG. 33 showing connections of the connection box to the connection location and to a prop;

FIG. 36 is a cross-section of the connection box of FIG. 33 illustrating the flow of cooling air through the connection box;

FIG. 37 is a schematic cross-section of another embodiment of a connection box coupled to a connection location;

FIG. 38 is a perspective view of a gas assembly of the connection box of FIG. 33;

FIG. 39 is a perspective view of a smoke generator of the connection box of FIG. 33;

FIG. 40 is a perspective view of a pilot burner of the connection box of FIG. 33; and

FIG. 41 is a schematic of a water supply system of the connection box of FIG. 33.

### DETAILED DESCRIPTION

Reference is now made in detail to the description of various embodiments as described herein and as illustrated in the drawings. While several certain embodiments are described in connection with this disclosure and the associated drawings, this disclosure is not limited to the specific embodiment or embodiments disclosed herein. On the contrary, all alternatives, modifications, and equivalents thereto shall be considered to be included in the disclosure.

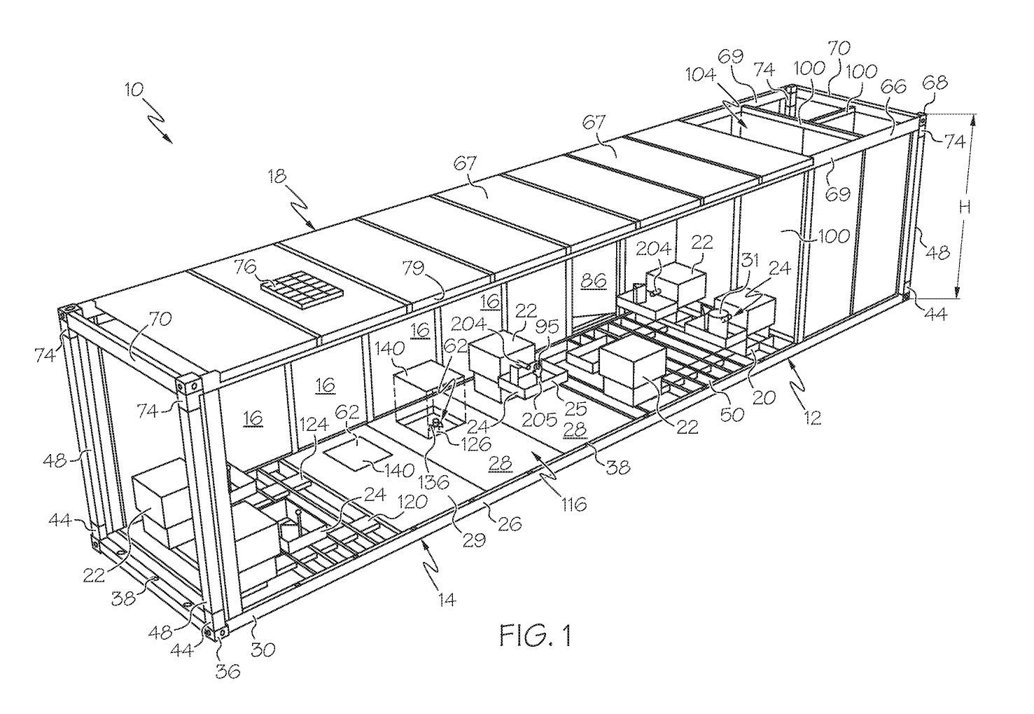

With reference to FIGS. 1-6, a modular fire training simulator, generally designated by reference number 10, comprises a structure 12, which is generally shaped as a rectangular prism in one case. The structure 12 can include a floor or floor structure 14, a plurality of outer/exterior wall panels 16 oriented perpendicular to the floor 14, a plurality of inner/interior wall panels 100 oriented perpendicular to the floor 14, and a roof or roof structure 18 oriented parallel to the floor 14. The exterior wall panels 16 can be configured and positioned to extend around an outer perimeter of the floor 14 and/or roof 18 and the interior wall panels 100 can be configured to be positioned on a portion of the floor 14 at least partially spaced away from the outer perimeter(s).

The structure 12 (including the floor 14, wall panels 16, 100 and roof 18) can be made of a variety of materials, but should be sufficiently strong to provide structural strength and integrity to the structure 12 and accommodate the rigors of firefighter training. In one case, the structure 12 is made of metal, such as corrugated metal. As will be described in greater detail below, some or all of the wall panels 16, 100 and/or the roof structure 18 can be removably attached to the floor 14, roof 18 and/or to a remainder of the structure 12 and be reattachable at differing positions to reconfigure the exterior and/or interior configuration of the structure 12.

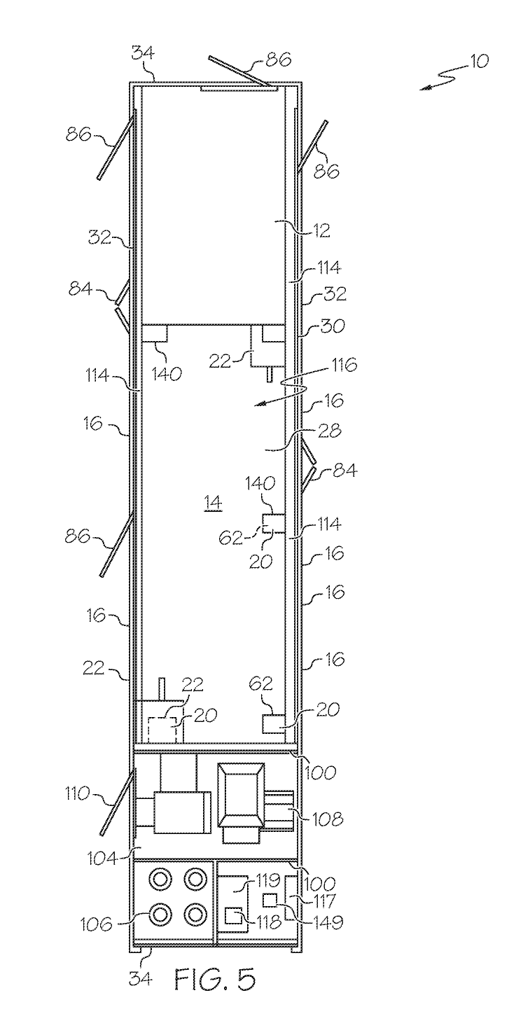

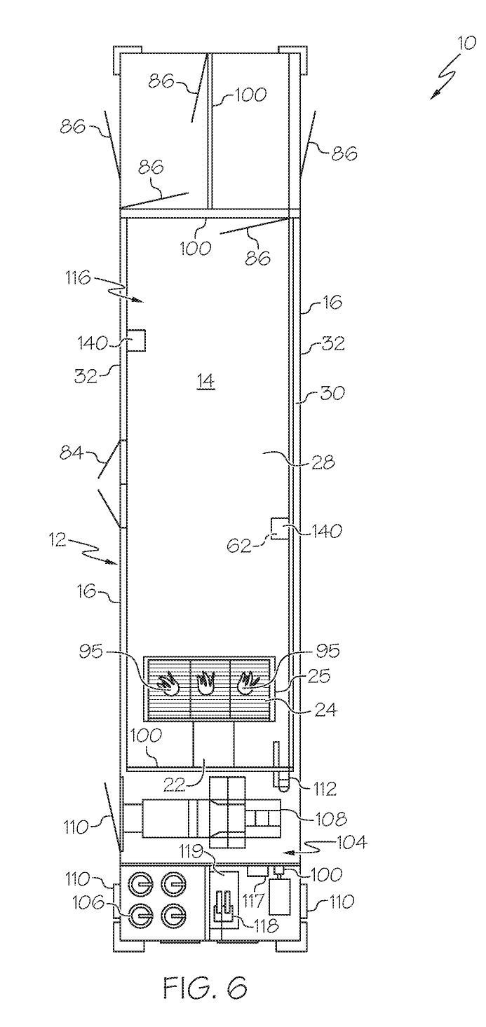

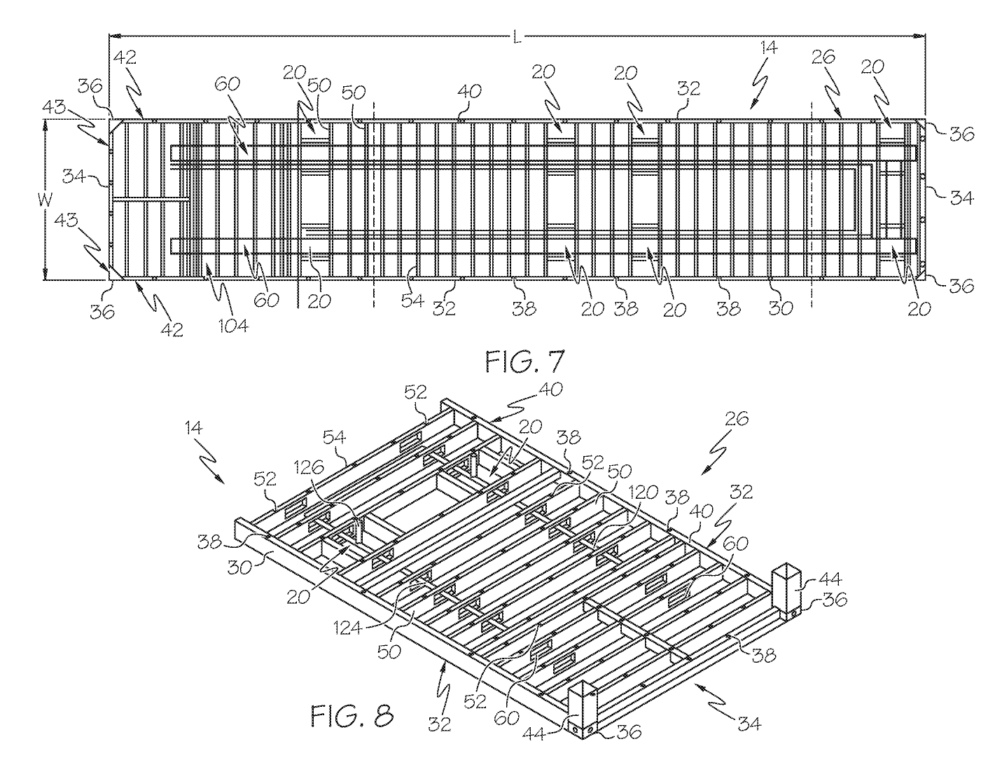

With reference to FIGS. 7 and 8, the floor 14 of structure 12 can include a base 26 and a generally flat, planar floor deck 28 (FIGS. 1-6) positioned on or above the base 26. In one case as shown in FIG. 1, the floor deck 28 can be made of or comprise a plurality of floor panels 29, as will be described in greater detail below. The base 26 of the floor 14 includes an outer frame or support structure 30 including a pair of longitudinal beams 32 and a pair of transverse beams 34 arranged in a rectangular shape and coupled together at four corner castings 36, each located at a corner of the outer frame 30. In one embodiment, the beams 32, 34 are made of steel, and as shown in FIG. 13 can be “C” beams in end view/cross section.

The frame 30, and more particularly the longitudinal beams 32, define a length L of the base 26/floor 14/structure 12. The frame 30, and more particularly the transverse beams 34, define a width W of the base 26/floor 14/structure 12. The beams 32, 34 can be arranged such that the outer frame 30 exactly or generally matches the size/outer perimeter of a standard sea transport or intermodal container, and in particular the corner castings 36 can be located at a standard position for such containers. The frame 30 can in one case have a length of either twenty feet or forty feet (about six meters or about twelve meters) and a width of eight feet (2.44 m). The roof 18 can have the same dimensions if desired.

Each of the beams 32, 34 can have a plurality of threaded holes 38 in an upper surface 40 thereof (FIGS. 1, 7 and 8). The holes 38 can be sized and configured to receive bolts therethrough to enable the exterior wall panels 16 to be coupled to the frame 30. In one case the wall panels 16 and/or beams 32, 34 are configured such that each wall panel 16 lines up with a plurality of threaded holes 38 of an underlying beam 32, 34, although the number of holes 38 can be varied as desired. Moreover it should be understood that the wall panels 16 can be attached to the beams 32, 34/frame 30/base 26/floor 14 by any of a wide variety of mechanisms (including clips, fasteners etc.), arrangements (such as interlocking or inter-engaging shapes, etc.) and the like.

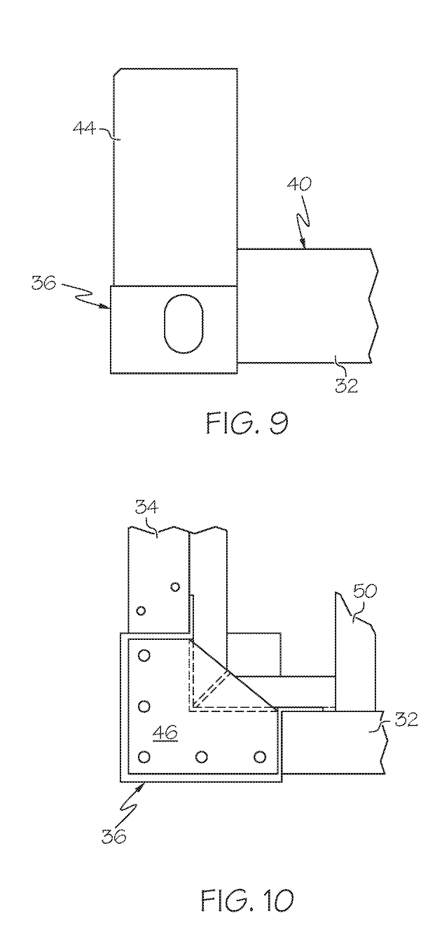

Each corner casting 36 is shaped to receive an end of a longitudinal beam 32 therein and receive an end of a transverse beam 34 therein, wherein the beams 32, 34 are oriented perpendicular relative to each other. Each corner casting 36 can be coupled to the associated beams 32, 34 by welding, bolting, or other methods or structures. With reference to FIGS. 8 and 9, a hollow upright support 44 and a generally triangular, stiffening connection plate 46 (FIG. 10) can also be welded, bolted, or otherwise coupled to each of the corner castings 36. Each upright support 44 can be configured to receive a corner beam 48 therein (FIG. 1), where the corner beams 48 extend generally upwardly and perpendicularly away from the base 26/floor 14/outer frame 30, and define a height H of the structure 12.

With reference to FIGS. 7 and 8, the frame 30 of the floor 14 can include a plurality of cross beams 50 positioned generally perpendicular to and extending between the longitudinal beams 32. Each cross beam 50 can be rigidly coupled at opposite ends to the longitudinal beams 32 by welding, bolting, or other rigid connecting methods or devices. As shown in FIGS. 8 and 12, each cross beam 50 can include a plurality of threaded holes 52 in an upper surface 54 thereof to facilitate attachment of the interior wall panels 100 to the cross beams 50, such as by receiving a fastener therethrough.

As shown in FIGS. 8, 11 and 13, each cross beam 50 can include a cutout, aperture or opening 56 extending therethrough, where the openings 56 are aligned to thereby form a channel 60 extending generally parallel to the longitudinal beams 32 and a plane of the frame 30. The channel 60/apertures 56 can have any convenient shape, including but not limited to square, rectangular, polygonal, circular, elliptical, or other shape.

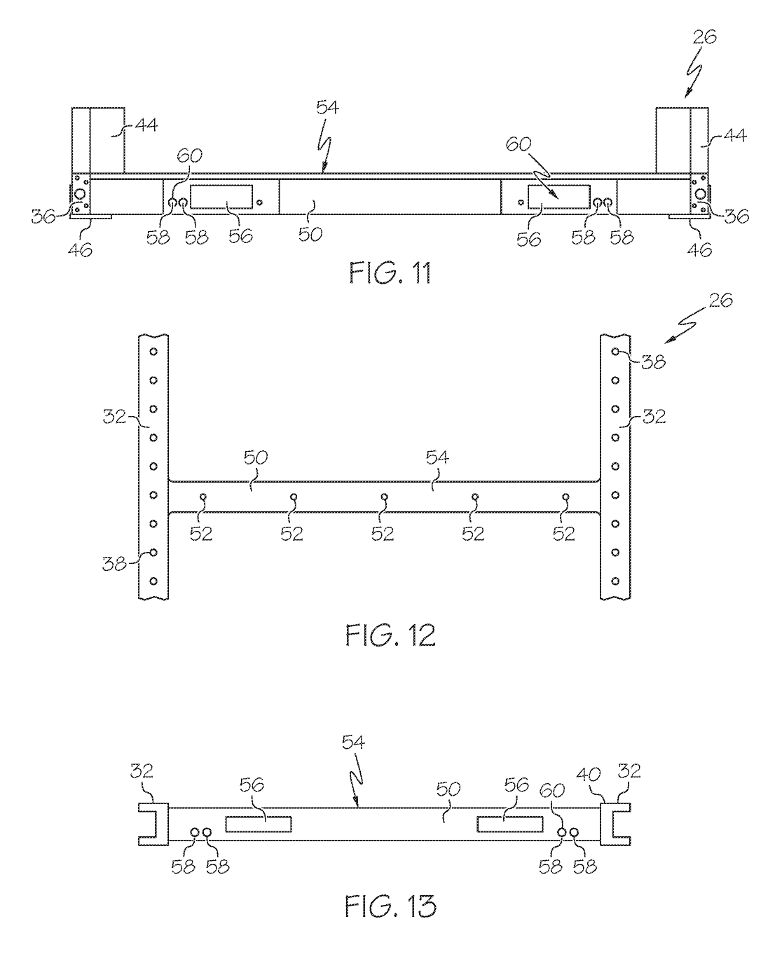

Each cross beam 50 can have two or more apertures 56 spaced along its length (FIG. 13; e.g. along with width dimension W of the simulator 10), and the two or more apertures 56 of each of the cross beams 50 can be aligned with the two or more apertures 56 of the other cross beams 50 to collectively form two or more channels 60 extending parallel to the floor 14. In one case each channel 60 extends entirely, or in another case extends at least about 60% along, the length L of the structure 12. Referring to FIGS. 11 and 13, each cross beam 50 can also include a one or more supplemental openings 58 (which are smaller than the apertures 56, and circular, in the illustrated embodiment) forming additional channels 60.

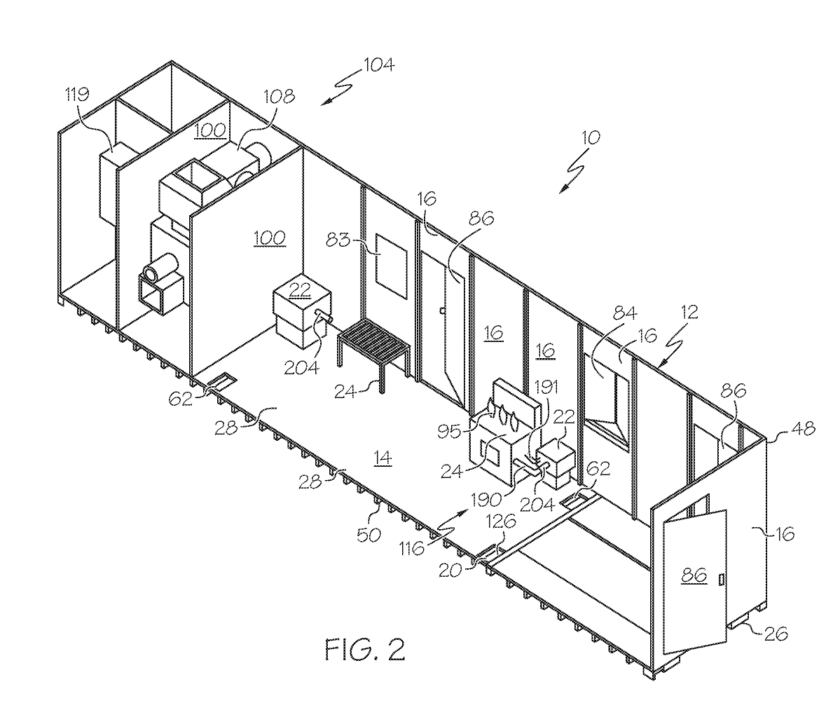

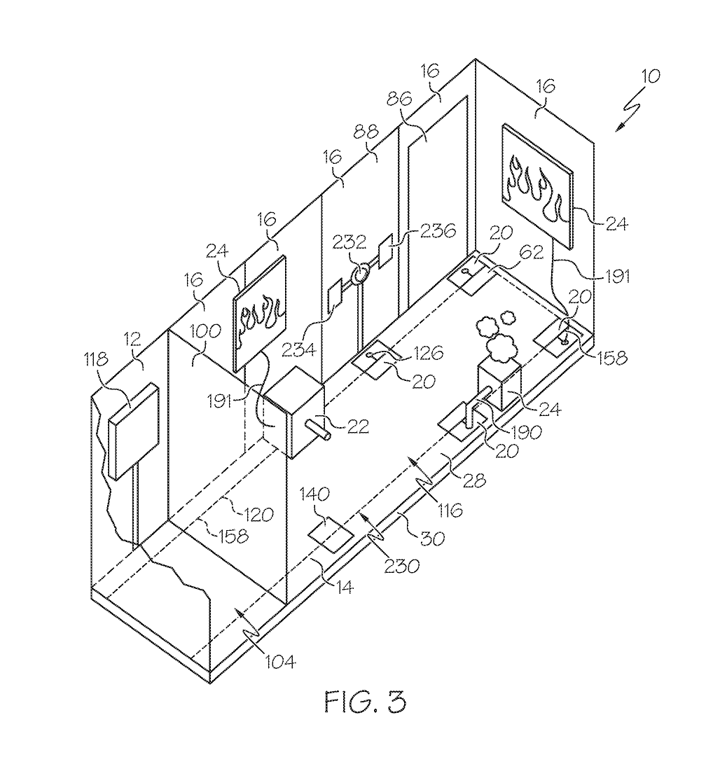

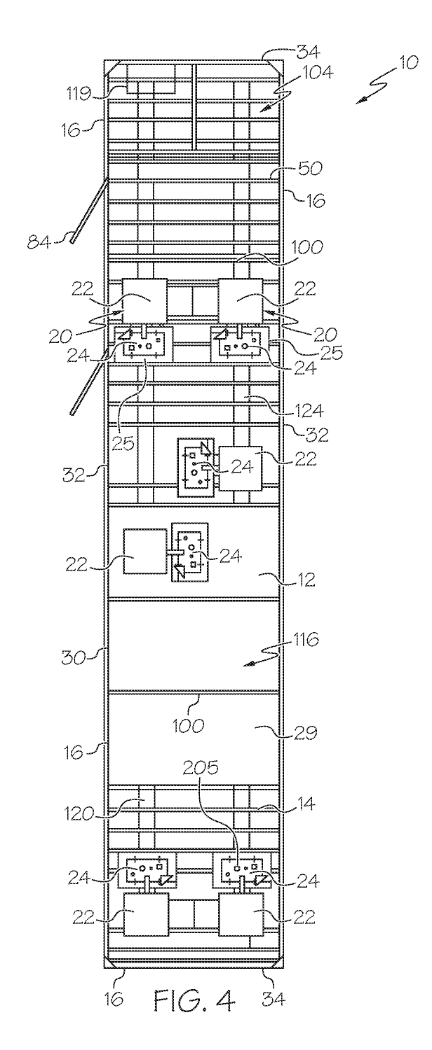

Referring to FIGS. 1 and 2, the floor deck 28 is positioned on top of the frame 30 and coupled to the upper surfaces 40 of the beams 32, 34 and to the upper surfaces 54 of the cross beams 50. In one embodiment, as shown in FIGS. 2 and 3 the floor deck 28 includes or is made of a generally continuous, integral structure, such as a steel plate or separate plates. In one embodiment, the floor deck 28 can be a single continuous panel extending the entire length and width of the floor frame 26. In another embodiment, the floor deck 28 can include one continuous floor panel located in or under a portion of the structure 12 (e.g. for a technical room 104) and another continuous floor panel for the simulation space 116 (e.g. the remaining floor space or volume of the simulator 10). The floor deck 28 can instead include or take the form of a plurality of floor panels 29 arranged generally side-by-side along the floor frame 26 (FIGS. 1 and 4). The floor deck 28 can also include a plurality of holes (not shown) positioned to be aligned with the threaded holes 38 and/or 52 in the floor frame 30 to provide access to the threaded holes 38/52 for coupling exterior wall panels 16 and interior wall panels 100 to the floor frame 30.

The floor 14/floor deck 28 can have a plurality of openings 62 that at least partially define and/or provide access to a plurality of connection locations 20 for connecting one or more connection boxes 22 to various utility systems or utility distribution systems 120, as will be described in greater detail below. Each opening 62 can thereby provide manual access to a utility distribution system 120 by a person supported on (standing on) the floor 14, as will be described in greater detail below. The floor deck 28 can include a plurality of covers 140, each of which is removably positionable over an opening 62/connection location 20 to cover the opening 62/connection location 20 when not in use.

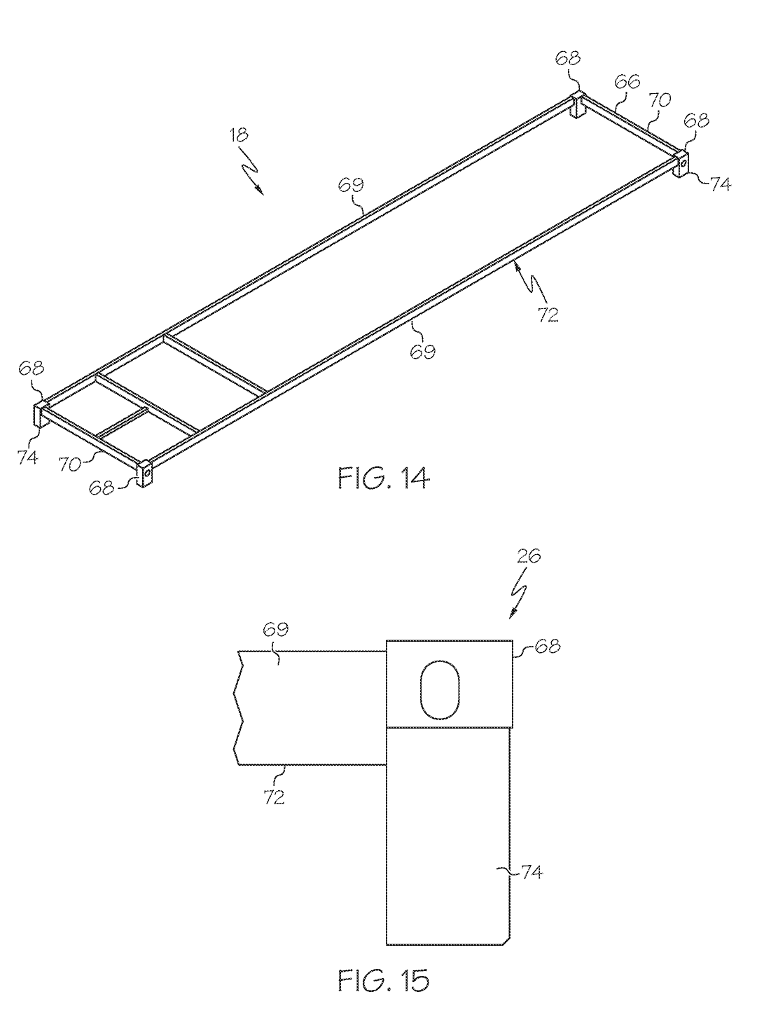

Referring to FIGS. 14-17, the roof 18 can include a roof frame 66 which includes two longitudinal beams 69 and two lateral beams 70 arranged in a rectangular shape and sized to match the outer frame 30 of the floor 14. The beams 69, 70 can be coupled together at or by four corner castings 68 at the corners of the roof frame 66, and have a configuration and properties similar to those outlined above for the frame 30 of the floor 14. The roof frame 66 can include various internal cross beams 61 if desired.

Each of the beams 61, 69, 70 can have a plurality of holes (not shown) in a lower surface 72 thereof, which can be threaded and located such that the wall panels 16 can thereby be coupled to the roof frame 66. However, it should be understood that the wall panels 16, 100 can be attached to the frame 66 by any of a wide variety of mechanisms (including clips, fasteners etc.), arrangements (such as interlocking or inter-engaging shapes, etc.) and the like. The holes in the roof frame 66, when utilized, can be arranged in a pattern the same as or substantially similar to a corresponding pattern of the holes 38, 52 of the floor 14.

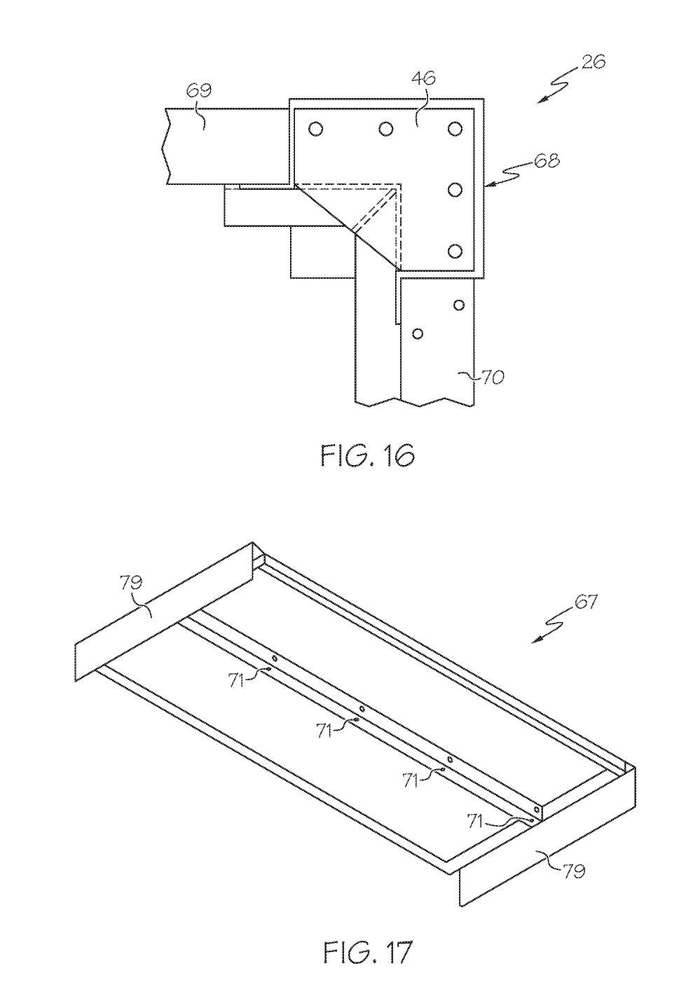

Referring to FIGS. 1, 14 and 15, a hollow downward support 74 and a generally triangular, stiffening connection plate 46 (FIG. 16) can be welded or otherwise coupled to each corner casting 68. Each downward support 74 can be configured or shaped to receive a corner beam 48 (FIG. 1) for mounting the roof frame 66 to the remainder of the structure 12.

With reference to FIGS. 1 and 17, the roof 18 can include a plurality of roof panels 67 that fit over and are removably coupled to the roof frame 66. Each roof panel 67 can have downwardly extending flanges 79 at opposed ends of the panel 67. When installed, the flanges 79 extend downwardly over an upper portion of the wall panels 16 and/or roof frame 66 (FIG. 1) to align each roof panel 67 and/or enable coupling of the roof panels 67. In one embodiment, the roof frame 66 has threaded holes (not shown) in an upper surface thereof and the roof panels 67 are coupled to the roof frame 66 by passing fasteners through the roof panels 67 and into the roof frame 66. Each panel 67 can include a set of openings 71 on a lower surface thereof to enable each roof panel 67 to be removably coupled to an interior wall or walls 100. When assembled the roof panels 67 are thus part of or define the roof 18. Thus the roof 18 and/or plurality of roof panels 67 are removably coupleable to wall panels 16, 100 and/or to each other and/or the roof frame 66 to thereby form a generally enclosed structure with the wall panels 16 and the floor 14.

Various ones of the roof panels 67 can include varying features to provide increased functionality to the structure 12. For example, one or more of the roof panels 67 can include a ventilation opening 76 (FIG. 1), ventilation grid, or hatch or the like which provides fluid communication from an internal space of the structure 12 to the surrounding ambient environment. One or more roof panels 67 can also or instead include one or more break away roof access panels by including, for example, wood or other breakable materials that a trainee can break during training to gain access to the internal space of the structure 12.

As shown in FIG. 1, each corner beam 48 can extend upwardly from each corner casting 36 of the floor frame 30 to a corresponding corner casting 68 of the roof 18 and support for the roof 18. The corner beams 48 can be generally “L-shaped” in end view, however it should be understood that the corner beams 48 could also have other cross-sectional shapes, such as rectangular, square, circular, or other shape. The corner beams 48 can be coupled to the connection plates 46 of the associated corner castings 36, 68 of the floor 14 and roof 18. When coupled to the connection plates 46, each corner beam 48 can abut against (or be received in) and can be laterally supported by the upward support 44 of the floor 14 and the downward support 74 of the roof 18. Once attached to the floor 14 and the roof 18, the wall panels 16 can provide additional support for the roof 18.

With reference to FIGS. 2-6, one or more of the wall panels 16 can have a building feature, which can include, but is not limited to, a window opening (e.g. an opening entirely internally positioned in the wall panel 16) and/or a window 84, a door opening (e.g. an opening positioned adjacent to or intersecting part of an outer perimeter of the wall panel 16) and/or a door 86, a ventilation opening or grate, a sacrificial plate, a chimney, or the like. FIG. 2 illustrates a wall panel 16 including a sacrificial plate 83 (FIG. 2) which can be made of a breakable material such as wood, plaster, metal etc. and be configured to breakaway or splinter upon proper use of a firefighting access tools (e.g., an axe, battering ram, etc.) used to gain access to buildings. The sacrificial panel 83 can provide additional training scenarios involving forced building entry. The wall panels 16 can be removed and rearranged to change a position of one or more of the building features (e.g., a window 84, door 86, ventilation opening, sacrificial plate 83 etc.). Changing the positions of wall panels 16 having building features enables differing fire training scenarios to be presented by the simulator 10.

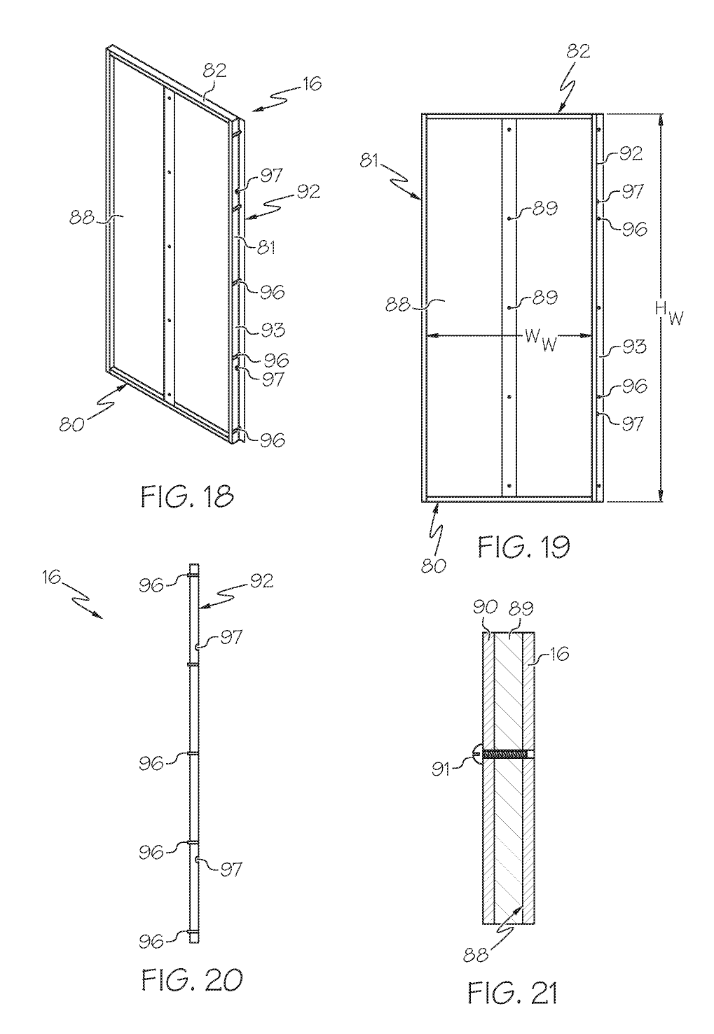

Referring to FIGS. 18-21, each of the plurality of wall panels 16 can be generally flat and planar, and rectangular in front view. Each wall panel 16 can have a width dimension W_{w} (FIG. 19) in a direction parallel to the floor 14 that is substantially less (e.g. less than ½ in one case, or less than ¼ in another case) than the width W (FIG. 7) of the structure 12. Each wall panel 16 can be made of or include any of a variety of materials, such as corrugated sheet metal. Each wall panel 16 can have a lower edge 80 and an opposed upper edge 82 that are removably attachable to the floor 14 and roof 18, respectively, for attaching each of the wall panels 16 to the structure 12. In particular, the lower edge 80 of each wall panel 16 can have a bolt hole pattern (not shown) corresponding to the pattern of threaded holes 38 (FIG. 7) on the upper surface 40 of the floor frame 30 for removably coupling each wall panel 16 to the floor frame 30. Similarly, the upper edge 82 of each wall panel 16 can have a bolt hole pattern corresponding to the pattern of threaded holes in the lower surface 72 of the roof frame 66 for removably coupling the wall panels 16 to the roof frame 66.

The wall panels 16 can be removably coupled directly to each other or can be removably coupled together using one or more connectors 92, as described in greater detail below. The wall panels 16 can include or have thermal isolation panels 89 and/or shielding panels 90 coupled to an inner surface 88 thereof. Each shielding panel 90 can face an inner volume of the structure 12 and be made from a fire retardant material, including metal such as steel, and be used to prevent or minimize damage to the wall panels 16 from heat generated by heat sources in the structure 12. Each thermal isolation panel 89 can be a fire retardant insulating material, such as mineral wool, for example. For applications in which heat or flame sources are not used, and for example only digital props are used within the simulator 10, the thermal isolation panel 89 can be made of glasswool and the shielding panel 90 can be made of galvanized metal. In one embodiment, the inner surface 88 of each wall panel 16 includes threaded holes that are configured to receive threaded fasteners 91 (FIG. 21), brackets, or the like (not shown) to couple the thermal isolation panels 89 and/or shielding panels 90 to each wall panel 16.

The simulator 10 can also include a plurality of fire retardant tiles (not shown) installed along the interior of the walls 16 and/or roof 18 and/or floor 14. The fire retardant tiles can include a silicate wool positioned within a heat resisting concrete tile. The fire retardant concrete tiles can be additionally supported by a supplemental steel frame or track (not shown) coupled to the interior of the structure 12. The fire retardant concrete tiles can be used to provide thermal isolation capable of withstanding higher temperatures, such as those temperatures common with dual-fuel type fires (carbonaceous and gas).

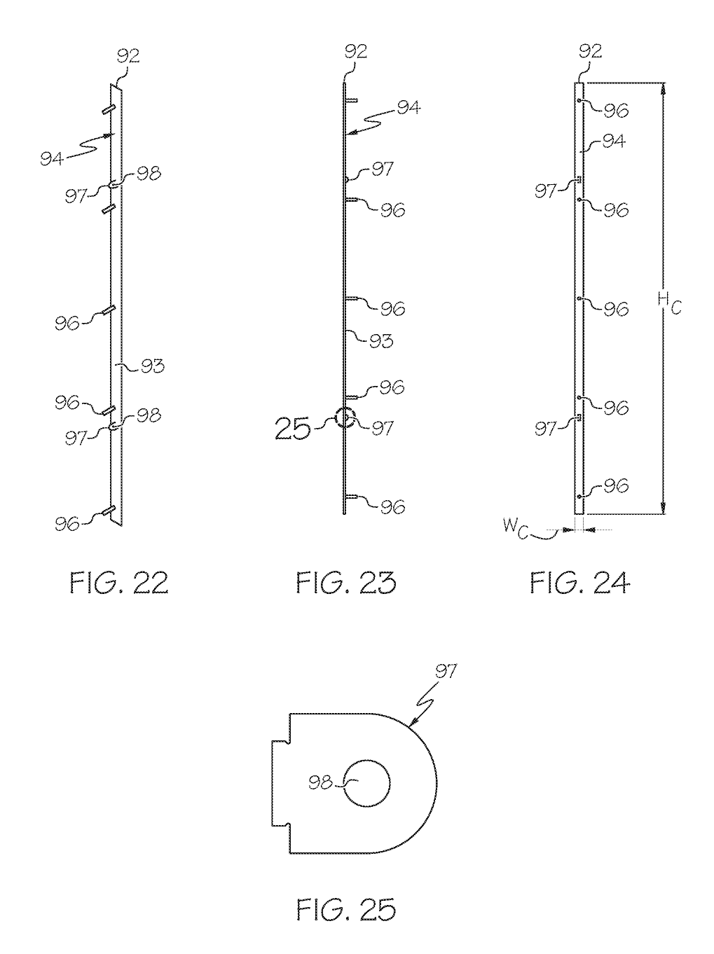

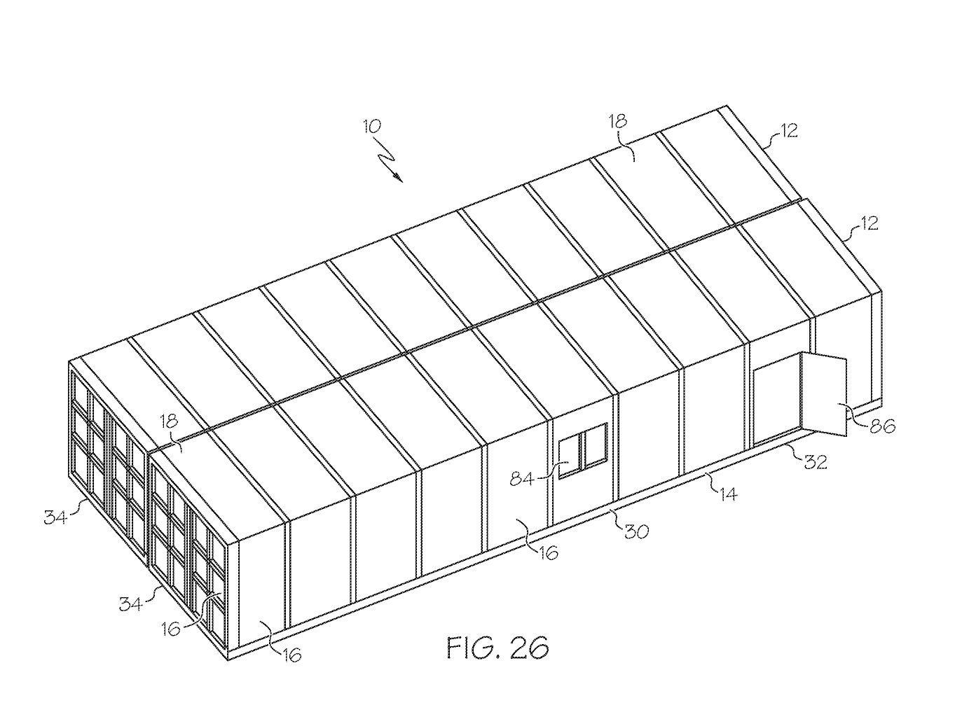

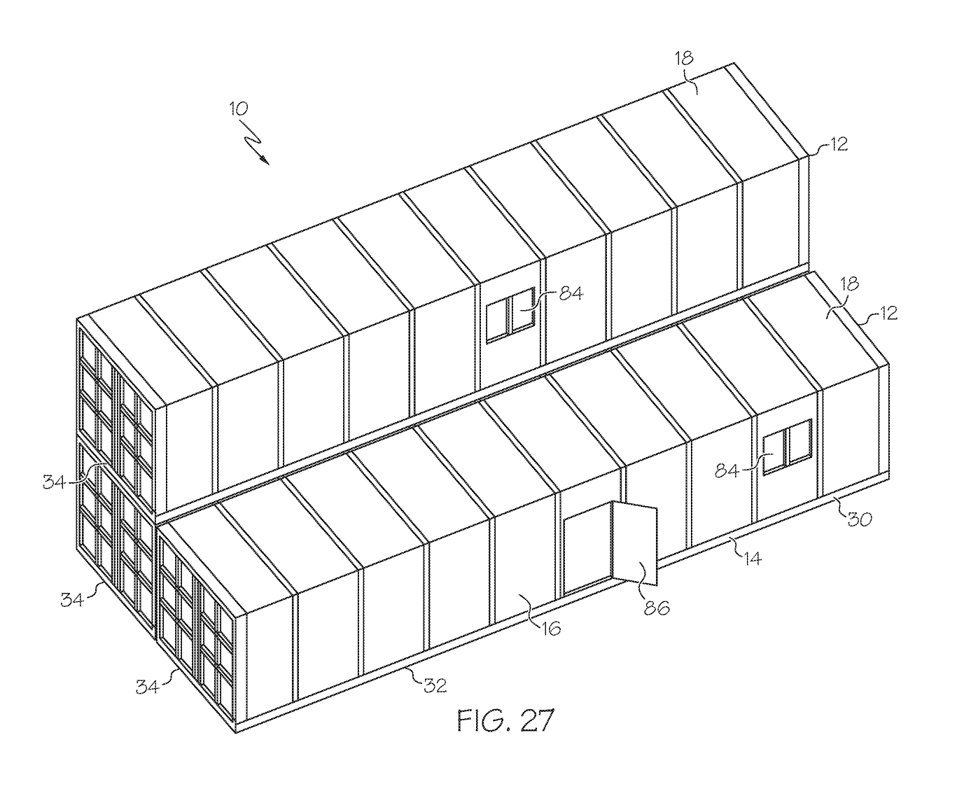

Referring to FIGS. 22-24, connectors 92 can be used to removably couple each wall panels 16 to an adjacent wall panel 16 and/or to an adjacent corner beam 48. Each connector 92 can have an elongated, flat base portion 93 and a plurality of cylindrical protrusions 96 extending generally perpendicular from an inner surface 94 of the base portion 93. The inner surface 94 of each connector 92 can also have a plurality of flat tabs 97 extending generally perpendicular from the inner surface 94, each of the tabs 97 having an aperture 98 (FIG. 25) for receiving a fastener (not shown) therethrough for coupling the connector 92 to an edge 81 (FIGS. 18 and 19) of the associated, adjacent wall panel 16.

Each connector 92 can have a height (FIG. 24) identical or generally similar to a height H_{w} (FIG. 19) of a wall panel 16 and a width W_{c} (FIG. 24) that is less than a width W_{w} (FIG. 19) of a wall panel 16. Each connector 92 can be installed between two adjacent wall panels 16 or between a wall panel 16 and a corner beam 48 to facilitate connection therebetween. The connector 92 can be coupled to one of the wall panels 16 by passing a fastener through the aperture 98 of a tab 97 of a connector 92. The connector 92/wall panel 16 can then be secured to another wall panel 16 or to a corner beam 48 by passing another fastener through another tab 97 of the connector 92 and into the wall panel 16 or corner beam 48. When so installed, the connector 92 is oriented so that the inner surface 94 of the connector 92 faces the interior of the structure 12 and abuts against the outer surfaces of the wall panels 16/corner beam 48. With the connector 92 in this orientation, the cylindrical protrusions 96 extend from the inner surface 94, between adjacent the wall panels 16 (or between the wall panel 16 and a corner beam 48), and towards the interior of the structure 12.

FIGS. 18-21 show a connector 92 coupled to the edge 81 of a wall panel 16, and ready for connection to another wall panel 16 or a corner beam 48. Each of cylindrical protrusions 96 has a threaded bore extending along a length of the protrusion 96. A channel (not shown) having an omega-shaped cross-sectional profile can be positioned between the wall panels 16 (or between a wall panel 16 and a corner post 48) and can be coupled to the connector 92 using fasteners (not shown) received through the omega-shaped channel and into the threaded cylindrical protrusions 96 of the connector 92. Tightening the fasteners that couple the omega-shaped channel to the connector 92 clamps the edges of adjacent wall panels 16 together.

Referring to FIGS. 1-6, the fire training simulator 10 can include one or more interior wall panels 100 which can be removably attachable to the floor 14, the roof 18 and/or wall panel 16. In one embodiment, the interior wall panels 100 can be substantially similar to or the same as the exterior wall panels 16 as described above and shown herein, and connected using the connector 92 or other structures. In addition, selected ones of the interior wall panels 100 can have an interior opening or window 84 or interior door opening or door 86 to permit access to adjacent areas otherwise separated by the interior wall panel 100.

One of the interior wall panels 100 can be positioned relatively close to one end of the structure 12, and span an entire width dimension w of the structure 12 to define a control room/technical room/service room or area 104. The technical room 104 can be positioned at the one end of the structure 12 and be generally isolated/segregated from the remainder of the structure 12, which forms a main compartment or simulation space 116 of the structure 12.

With reference to FIGS. 5 and 6, the technical room 104 an be divided into various sub-areas by one or more internal wall panels 100. Various equipment and the like can be positioned in the technical room 104, such as a fuel supply 106 (such as fuel gas containers), a ventilation system 108 for the technical room 104 and/or simulation space 116, a main controller 119, a smoke fluid distribution source/system 148, an electrical power source/system 117, a safety system controller/computer/processor 118, and/or other equipment for providing utilities to and managing the simulation space 116 of the simulator 10, such as a liquid smoke supply, utility connections, utility manifolds, power distribution equipment. The technical room 104 may also include a flash-over system 112 for simulating a flash-over condition in the simulation space 116.

As noted above, the structure 12 can include one or more wall panels 16 having a door 110 to provide ingress to and egress from the technical room 104. In one case the technical room(s) 104 can only be accessed/manually entered from an exterior position of the structure 12 through a door 110, and no access/manual entry is provided to the technical room 104 from the simulation space 116.

The exterior wall panels 16, roof panels 67, floor deck 28/floor panels 29 and interior wall panels 100 can all be removably connectable to the floor 14 and/or the roof 18 as outlined above. The training scenario presented by the fire training simulator 10 can thus be changed as desired by removing and repositioning the modular wall panels 16 to reposition windows 84, doors 86, sacrificial plates 83 and/or other wall features; removing and repositioning roof panels 67 to reposition vents 76, roof access doors/hatches or other roof features; by repositioning the interior wall panels 100 to change the internal structural layout of the fire training simulator 10; and/or by changing features of the floor 14. The modular nature of the wall panels 16, 100, floor panels 29 and ceiling panels 67 enables the operator to change the fire training simulator 10 between multiple training scenarios, which also provides ease of replacing damaged or worn components.

FIG. 5 shows the simulation space 116 of the fire training simulator 10 having two windows 84, four doors 86, and no interior wall panels 100 (except to define the technical room 104). In the simulator 10 of FIG. 6, compared to FIG. 5, certain exterior wall panels 16 have been repositioned and/or interchanged such that the simulation space 116 has one window 84 and two doors 86 at one end thereof. The simulation space 116 in FIG. 6 also has two internal wall panels 100 with interior doors 86 positioned in the interior wall panels 100 to further change the training scenario presented by the fire training simulator 10. FIGS. 1-4 illustrate further alternate configurations for the simulation space 116. As a trainee experience the same training scenario, the trainee can get used to the scenario and complacent about the training. The ability to change the configuration of the fire training simulator 10 to present different training scenarios can reduce and/or prevent this familiarity and complacency, and provide more meaningful training.

As shown in FIGS. 26 and 27, multiple structures 12 can be coupled together in a side-by-side (FIG. 26) and/or stacked (FIG. 27) configuration to provide expanded training capabilities of the simulators 10. Aligned openings or doors 86 in exterior wall panels 16, or simply omitting some or all wall panels 16 along common sides can allow access between laterally positioned structures 12, and similar arrangements with roof panels 67 and floor panels 29 can provide access between vertically stacked structures 12. For vertically stacked structures 12, one or more internal or external stairways, ladders or the like (not shown) can be installed to provide access to the upper structure 12.

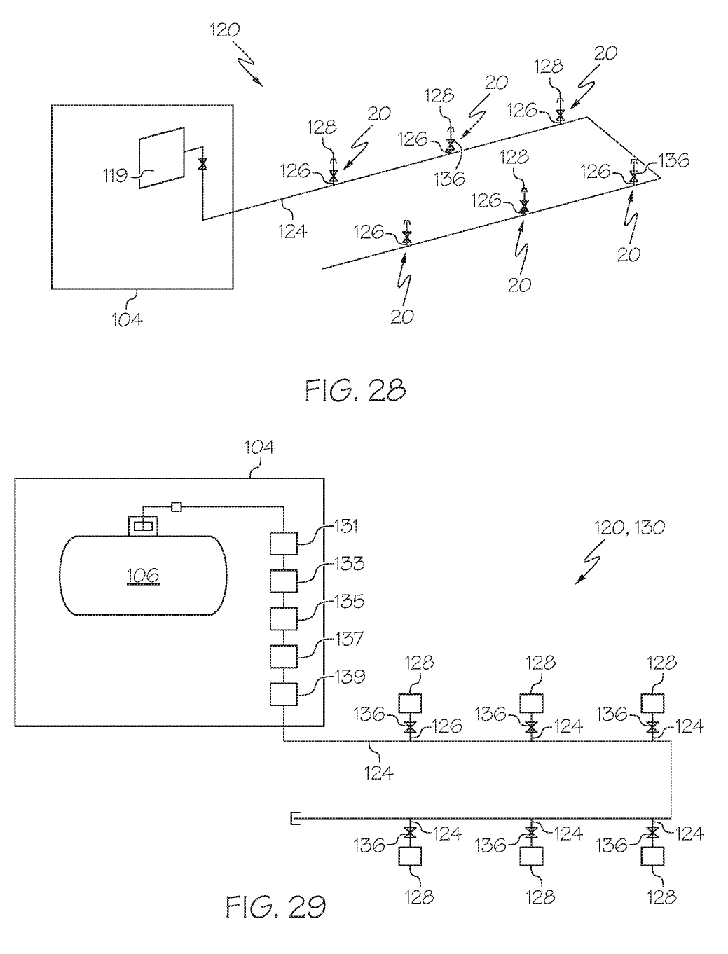

Referring to FIGS. 8 and 28, the simulator 10 can have one or more utility distribution systems 120 positioned within or below the floor 14 for distributing one or more utilities to the plurality of connection locations 20. The one or more utilities can include, but are not limited to, fuel, water or other extinguishants, fluid drain (e.g. plumbing drain lines), electrical power, data and communication systems or wiring, artificial smoke fluid or other fluids, air, safety systems, or the like. Each utility distribution systems 120 can originate at or pass through or under the technical room 104, or originate at a source outside of the structure 12, and include portions positioned in the floor 14 below the simulation space 116.

Each utility distribution system 120 can generally include a main line 124 extending in and/or along the channels 60 in the floor 14 from the technical room 104 through/under at least part of the simulation space 116 of the structure 12. In one case each main line 124 extends to or adjacent to an end of the floor 14 opposite the technical room 104. When the utility distribution system 120 is required or desired to form a closed loop, or in other cases as desired, each main line 124 may return to a position in or below the technical room 104. Each utility distribution system 120 can include a plurality of branches 126, with each branch 126 extending from the main line 124 to one of the connection locations 20 in the floor 14. In this manner each connection location 20 can include an end opening/access opening of a branch 126, that may be closed by a valve 36 or the like, and/or terminate at a connector 128 providing access to and communication to the utility distribution system 120. Multiple utility distribution systems 120 can be utilized and if desired terminate at each connection location 20, and provide access thereto.

The branches 126 of each utility distribution system 120 can terminate in a utility connection 128 at, adjacent to or defining the connection locations 20. Each utility connection 128 can include or take the form of a port coupling or connector and/or valve that provides access to or use of the associated utility, such as quick coupling, electrical receptacle or electrical connector, data port, drain or other piping connection.

Each main line 124 and/or branch 126 can take the form of piping or conduit for fluidly transporting a fluid, such as fuel gas or fluid, water, smoke fluid, fluid to be drained etc., or electrical conduit containing wiring and/or the wiring itself for transmitting electrical power, data, etc. As noted above, multiple distribution systems 120 can be positioned in the floor 14, and each distribution system 120 can have generally the same structure/layout using the main/branch structure outlined above, or the various distributions systems 120 can have differing structures or layout, and may not necessarily utilize a main/branch structure. For example, when a distribution system 120 takes the form of electrical wires, if desired each wire may be directly connected from one end point to the other if desired.

When the floor 14 has two or more channels 60, the main line 124 (if utilized) can extend from the technical room 104 to the opposite end of the structure 12 along one of the channels 60 and then return back towards the technical room 104 through another of the other channels 60. Alternatively all portions of a main line 124 can be positioned in a single channel 60. Each of the branches 126 (if utilized) can fluidly and/or electrically connect the associated main line 124 to one of the connection locations 20, which in one case are positioned in or below the floor 14/floor deck 28 (FIG. 8). By incorporating each of the utility distribution systems 120 into the floor 14, the simulator 10 can be disassembled and packed flat for more efficient transportation of the simulator 10 to a new site. In one case the simulator 10, structure 12 and/or floor 14 lacks any components permanently coupled thereto that protrude upwardly from the floor 14, or from the floor deck 28, to enable the packing and shipping of the floor 14 as a flat structure that can be shipped to a site, and the wall panels 16, 100 and roof 18 can be coupled thereto as desired on site to form the structure 12. The floor 14 may thus be able to be easily transported by a standard truck, train, vessel or the like.

FIG. 29 illustrates a utility distribution system 120 in one illustrative case in the form of a fuel distribution system 130. The fuel distribution system 130 can include or be removably coupled to one or more fuel sources, such as a fuel supply container or containers 106, which can be positioned in the technical room 104 and/or be positioned external to the structure 12. The fuel distribution system 130 can include a safety shutoff valve 131, pressure governor 133, overpressure relief valve 135, filter 137, and one or more test points 139 positioned in the technical room 104 and in the main line 124. The main line 124 of the fuel distribution system 130 can extend through the channels 60 (FIG. 8), and the fuel distribution system 130 can include a plurality of branches 126 that extend from the main line 124 to each of the connection locations 20.

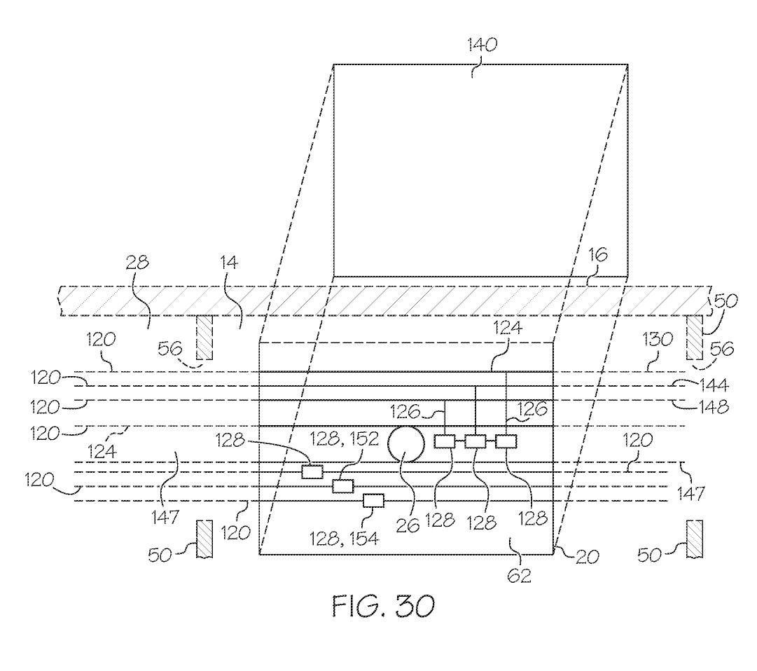

The utility distribution system 120 can in another case include or take the form of an air distribution system configured to deliver cooling air to the connection location 20, and more particularly to the connection boxes 22 which are positionable at the connection locations 20, as will be described in greater detail below. The air distribution system can include air ducts 147 (see FIGS. 30-32) located in the channels 60, and can also include an air blower or other air movement device in fluid communication with air ducts 147 to convey cooling air to each of the connection locations 20. The air movement device can be located within the technical room 104 or outside of the structure 12 and can have an inlet open to ambient air or coupled to a heat exchange device to convey ambient air or cooled air, respectively, through the cooling air ducts 147. Cooling air from the cooling air distribution system can be used to provide cooling to one or more internal components of the connection boxes 22, as will be described in greater detail below. Valves, baffles, deflectors and the like can be positioned in the cooling air distribution system and be operatively coupled to the controller 119 or the like to control the flow of air therethrough.

The utility distribution system 120 can in another case include or take the form of a smoke fluid distribution system 148 extending from a source of smoke fluid 149 in e.g. a liquid or gaseous state (FIG. 5) positioned in one case in the technical room 104 to the connection locations 20 and include conduits positioned in the channels 60 in the floor 14. The smoke fluid distribution system 148 can include a pump to convey the smoke fluid through the smoke fluid distribution system 148 and a valve 136 in each branch 126 of the smoke fluid distribution system 148 to prevent distribution or flow of smoke fluid through the branches 126 when not in use.

The utility distribution system 120 can in another case include or take the form of a power distribution system 150 extending from an electrical power source 117 (FIG. 5) and include wires positioned in the channel(s) 60 in the floor 14 extending to a connection location 20. Each branch 124 of the power distribution system 150 can terminate in an electrical connection 128, such as an electrical receptacle, at each connection location 20. The utility distribution system 120 can also take the form of a data system terminating at one or more data ports 128/152 at each connection location 20. Each of the water distribution system, smoke fluid distribution system, cooling air system, drain system, safety network, data system, power distribution system, or other utility distribution system can be incorporated into the floor 14 in a manner similar to the fuel distribution system 130 or other utility distribution system outlined above.

Referring to FIGS. 1-6, the floor 14 of the structure 12 can include, define or accommodate a plurality of connection locations 20, where each connection location 20 provides access and/or fluid, electrical, operative and/or other connection to one or more fluid, electrical, data, communication, or other utility distribution systems 120. The simulator 10 can include or be used in conjunction with one or more pilot boxes or connection boxes 22 that are removably connectable to the utility distribution systems 120 at each connection location 20. Each connection box 22 can, in turn, be removably connectable to one or more props 24 to thereby provide a fluid, electrical, data, communication or other utility connection between the utility distribution systems 120 and the props 24, as will be described in greater detail below. The connection boxes 22 and/or props 24 can thereby provide live fire and/or simulated fire training scenarios and can be positioned at different connection locations 20 to change the training scenario presented by the simulator 10. The props 24 can vary as desired, but can be shaped and configured to mimic, and present burn behavior, of devices, structures and the like expected to be present in the structure 12, such as appliances (e.g. a stove prop 24 shown in FIG. 2, or ovens, dishwashers, heaters etc.), furniture (such as couches, chairs, tables), etc.

With reference to FIG. 1, in one case a prop 24 can take the form of a fire tray and include a generally horizontally oriented tray 25 having a vertically oriented burner or burner element 205 positioned therein. The tray 25 is fillable with water to create a water bath to provide a safety feature, and the flow of water into the tray 25 can be controllable by the controller 119, as will be described in greater detail below. The burner element 205 may be ignitable by a remotely controllable flame, spark or ignition source (e.g. in one case a pilot tube or pilot burner 204) to enable the burner element 205 to burn fuel supplied thereto by a fuel utility distribution system 120. Each prop 24 may include or be coupled to a plurality of temperature sensors or other sensor for detecting an extinguishant (either real or simulated) directed at the prop 24 and/or for fire proving. A drain utility system 120 may be coupled to the tray 25 to drain the water therefrom. The tray 25 can include a level sensor operatively coupled to the controller 119 by a communication utility system 120 to measure the amount of water in the tray 25. FIG. 1 also illustrates another prop in the form of a cooking pot 31 positioned in a tray 25 and configured to emit a flame during training operations.

The plurality of connection locations 20 can be positioned on, in and/or below the floor 14 and spaced apart from one another about the simulation space 116. Each connection location 20 can include or take the form of an access opening 62 in the floor 14 and/or provide access to a utility distribution system 120, such as by a connection 128 that is accessible through the opening 62. As noted above, a cover 140 can be removably positioned in/over each opening 62 when the connection location 20 is not in use. In one embodiment, each cover 140 can provide thermal and/or electrical insulation to the connection location 20 and be flush or generally flush with the floor 14 and/or floor panel 28 when installed. Each cover 140 can thereby prevent trainees from tripping on or stepping into the opening 62/connection locations 20 and protect the utility connections 128 therein.

The connections 128 on each of the utility branches 126 can be used to connect a pilot box or connection box 22 to one or more, or all, of the utility distribution systems 120 at the connection location 20. Alternatively, in some cases a prop 24 can be directly connected to one, more, or all utility distribution system 120 at a connection location 20, and in this case the connection box 22 may not be needed.

Each connection location 20 can be used to connect a connection box 22 for controlling the flow of one or more utilities to or from a prop 24 and/or controlling and operating the prop 24. FIG. 3 illustrates a prop 24 in the form of a virtual/simulated fire training device, such as a screen, monitor, display, digital flame panel or the like connected a utility distribution system 120 via a connection box 22, and another display screen 24 directly connected to a utility distribution system 120 at a connection location 20 without a connection box 22. FIG. 3 also illustrates another prop 24 in the form of a stand-alone smoke machine/generator. Various other props 24, directly connected to a utility distribution system 120 or connected via a connection box 22, can be used including speakers/sound systems, flame sources or other type of hazardous condition simulating equipment. The simulator 10 can also utilize other equipment, such as gas detectors, temperature sensors, interior lighting, or other devices connected to the utility distribution systems 120 at the connection locations 20 or at other locations.

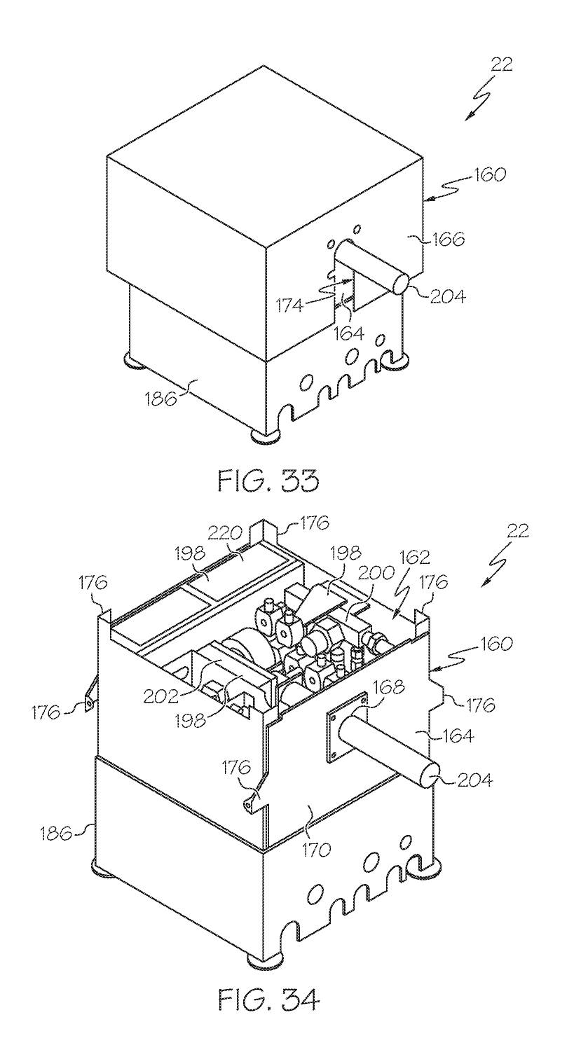

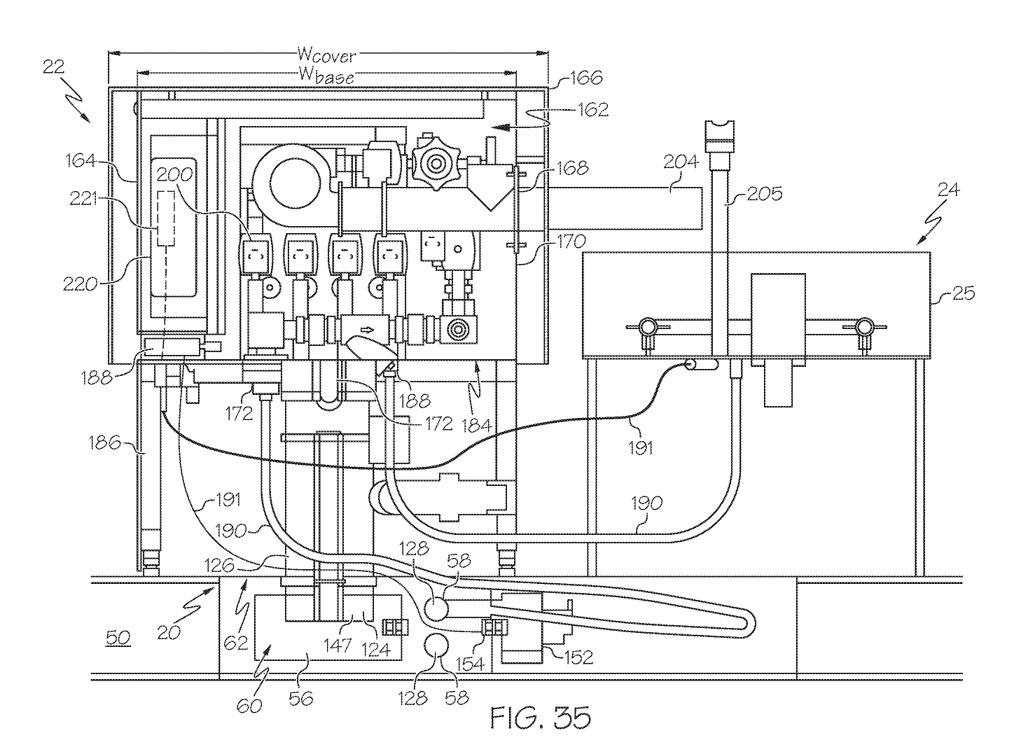

Referring to FIGS. 33-35, each connection box 22 can in one case include or take the form of a universal pilot box unit capable of being connected to many different types of live fire training props 24 or burner objects, including both gas fired and dual fired (gas and wood) props 24 or simulated fire devices. Each connection box 22 can include a shell or enclosure 160 that can be a hollow metal box or shell defining an internal cavity 162 (FIG. 34), and can be made of any of a wide variety of materials. The enclosure 160 can be a double hull shell which provides increased thermal insulation and safety, and can include a base 164 and a cover 166. The base 164 can be shaped as an open-sided rectangular prism or box defining the internal cavity 162 in which are positioned the various internal components of the connection box 22. The cover 166 can fit over and cover the internal cavity 162. With reference to FIG. 35, the cover 166 can have an inner-most width (and/or length) dimension W_{cover} that is larger than an outer-most width (or length) dimension W_{base} of the base 164 so that the cover 166 can be installed over the base 164 with a gap 178 therebetween.

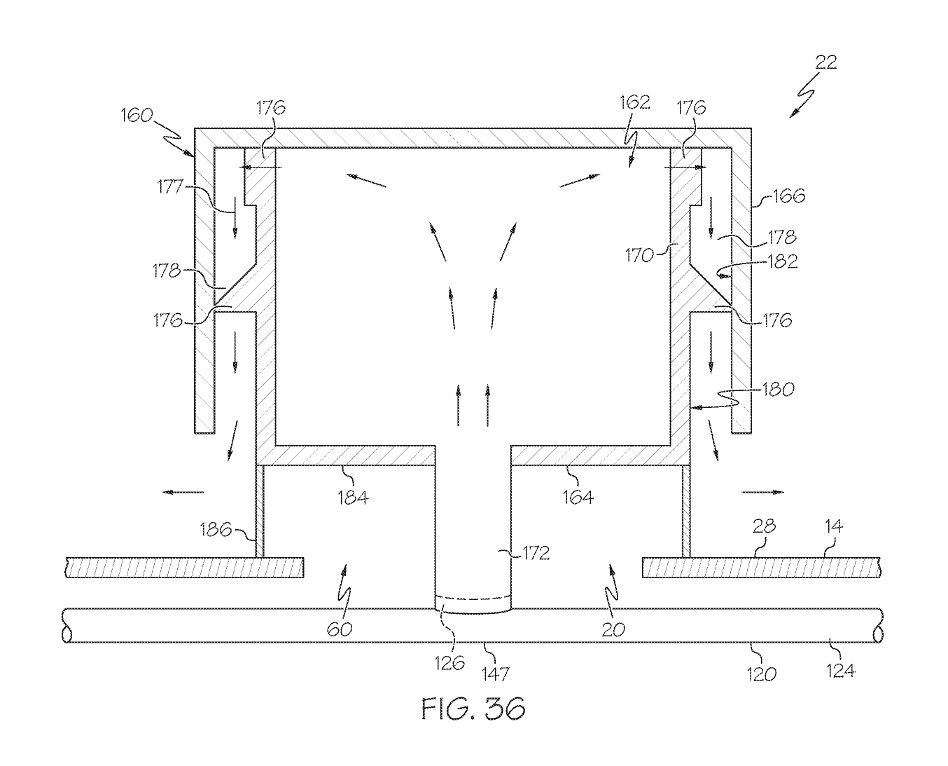

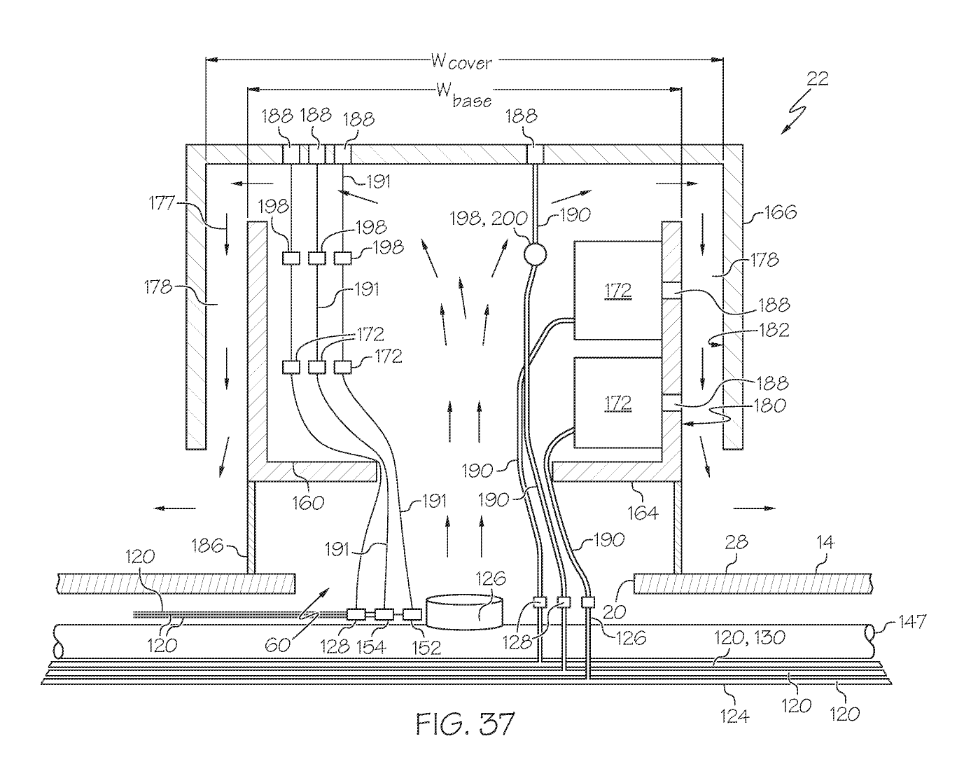

Referring to FIGS. 34 and 36, the base 164 can include a plurality of spacing flanges or tabs 176 extending outward from the side walls 170 and/or top edges of the base 164. Alternately, the tabs 176 can be coupled or integral with the cover 166 and extend inward toward the base 164, and if desired the tabs 176 can be removably attachable to the base 164 and/or cover 166. When the cover 166 is installed on the base 164, as shown in FIGS. 36 and 37, the flanges/tabs 176 define the gap 178 between an outer surface 180 of the base 164 and an inner surface 182 of the cover 166. The gap 178 provides an exit path for cooling air, which can enter the connection box 22 from an inlet air connection 172 (FIG. 36) and/or directly from a branch 126 of the cooling air utility distribution system (FIG. 37).

The flow path 177 of cooling air is indicated in FIGS. 36 and 37 by the arrows entering from the air utility distribution system 120, through an inlet 172 coupled to the base 164 (FIG. 37), and out through the gap 178 between the base 164 and cover 166. The air flowing through gap 178 conveys heat, through convection, from the inner surface 182 and/or the internal cavity 162 of the cover 166 out of the enclosure 160. In one embodiment, the gap 178 extends substantially around an entire outer periphery of the base 164, although the gap 178 need not necessarily extend around the entire outer periphery of the base 164.

The base 164 can have one or more openings 168 (FIGS. 34 and 35) in a side wall 170 thereof to allow passage of a pilot burner 204 through the side wall 170 so that the pilot burner 204 be positioned adjacent to a burner 205 of the prop 24 to ignite the burner. The cover 166 can have one or more U-shaped cutouts 174 (FIG. 33) to accommodate the pilot burner 204 extending from the base 164. The connection box 22 can also include various other components positioned in the internal cavity 162 thereof, including an over-temperature detection system, a pilot burner system 204 (FIG. 40), a pilot flame ignition system, control system, and/or safety system component.

The connection box 22 can include or be placed on or include a stand 186 which in turn rests on the floor 14 or the floor deck 28 to raise the connection box 22, for example for ease of connection to a prop 24 and/or to provide access to utility connections 128 of the connection location 20 and/or connections 172, 188 of the connection box 22. In one embodiment, the stand 186 can have a plurality of positioning pins (not shown) extending from a bottom surface thereof and receivable in a plurality of openings (not shown) of the floor 14 configured to receive the positioning pins, thereby fixing a position of the connection box 20 relative to the floor 14 and preventing the connection box 20 from tipping over or moving during use or training operations. In this manner the connection box 20 can be removably attachable to the floor 14.

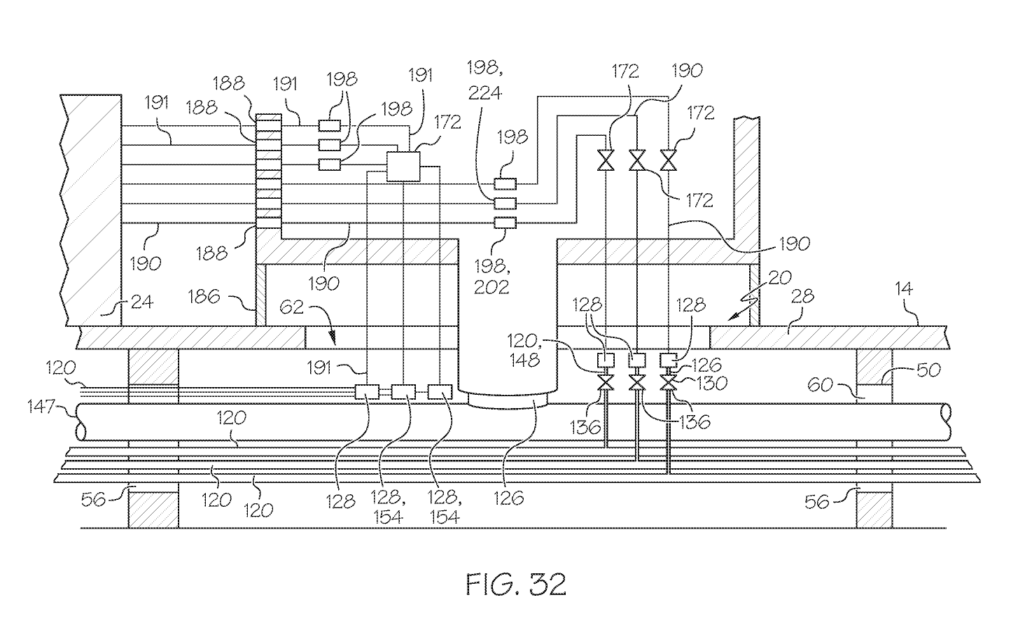

The connection box 22 can include a plurality of inlets, ports, plugs, connections or inlet connections 172 etc. (shown schematically in FIGS. 32 and 37) each of which is connectable via a hose or conduit 190, cable 191, wireless connection, or other connection device or system to a utility distribution system 120, such as through utility connections 128. The connection box 22 can include a plurality of outlets, ports, plugs, connections, outlet connections, etc. 188, and each inlet connection 172 can be operatively coupled to an outlet connection 188 via a hose 190, cable 191 (or wireless connection) or other connection device, to thereby connect each outlet connection 188 to a utility distribution system 120. Each outlet connection 188, in turn, is connectable to a prop 24 or other device, thereby fluidly, electrically, or otherwise coupling the prop 24 to one or more of the utility distribution systems 120. In one case, the inlets 172 and outlets 188 can be positioned in a bottom wall 184 of the base 164, although the inlets 172 and outlets 188 are shown in differing positions in FIGS. 32 and 37 for ease of illustration. As shown in FIG. 37, in some cases the inlet 172 and outlet 188 can be positioned adjacent to each other and integrated or essentially integrated.

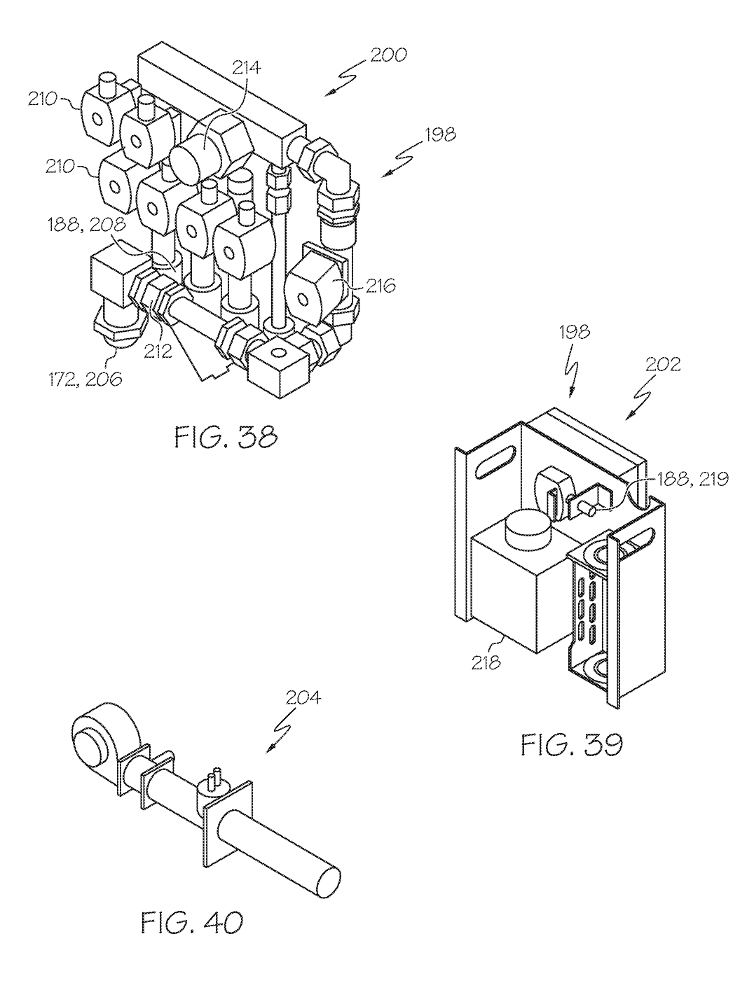

Referring to FIGS. 32, 34 and 35, each connection box 22 can include one or more utility subsystems 198 positioned therein, each utility subsystem 198 having an inlet coupling or input connection for coupling the subsystem 198 to an associated port/connection 172, and thereby with a utility distribution system 120. For example hoses 190 cables 191, wireless connections or other connections can be used to fluidly, electrically, operatively or otherwise couple the inlets or inputs of each utility subsystems 198 to the associated connection system 172/utility distribution system 120. The utility subsystems 198 can include a fuel gas utility subsystem 200 (see FIG. 38), a water supply subsystem, fluid drain line subsystem, a smoke distribution subsystem 202 (see FIG. 39), a water supply subsystem 224 (see FIG. 40) and other subsystems as desired to connect with the associated utility distribution system 120 and to control the flow and distribution of the utility of each utility distribution system 120.

Referring to FIG. 38, the fuel gas utility subsystem 200 can be positioned in the connection box 22 and include a fuel gas inlet 206/inlet 172 removably fluidly coupleable to the fuel gas distribution system 120/130 (FIG. 29) at the connection location 20. The fuel gas utility subsystem 200 can also include one or more fuel gas outlets 208/outlets 188 removably coupleable to one or more props 24 via a hose 190 (FIG. 2), conduit, etc. The fuel gas utility subsystem 200 can act as a manifold to fluidly couple the fuel distribution system 130 to the prop(s) 24 or other devices.

The fuel gas utility subsystem 200 can include one or more control valves 210, check valves 212, pressure relief valves 214, safety shutoff valves 216, pressure regulators, sensors, flow meters, or other devices. The control valves 210 and/or the automated shutoff valve 216 can be electrically coupled to the main controller 119 and/or a subcontroller 221 of the connection box 22 to control the flow of fuel gas through the fuel gas utility subsystem 200. For example, in one case the control valves 210 can be electrically coupled to the main controller 119, such that an operator in the technical room 104 can control the control valves 210, or the main controller 119 may be operated without any human interaction, to thereby control the fuel provided to the props 24 during a simulation. The fuel gas utility subsystem 200 can have multiple gas outlets 208 and multiple control valves 210 for coupling the fuel gas utility subsystem 200 to a prop 24 having a burner 204 with multiple fuel gas inlets, or for connection to multiple props 24.

In one case, one of the utility distribution systems 120 is a power and/or data transmission system that extends from the main controller 119 to the fuel gas utility subsystem 200 so that the main controller 119 can thereby electrically control the fuel gas utility subsystem 200. In this case the utility distribution system 120 that which electrically or operatively controls the fuel gas utility subsystem 120 can terminate short of, and not extend all the way to, the prop 24 or other device coupled to the connection box 22.

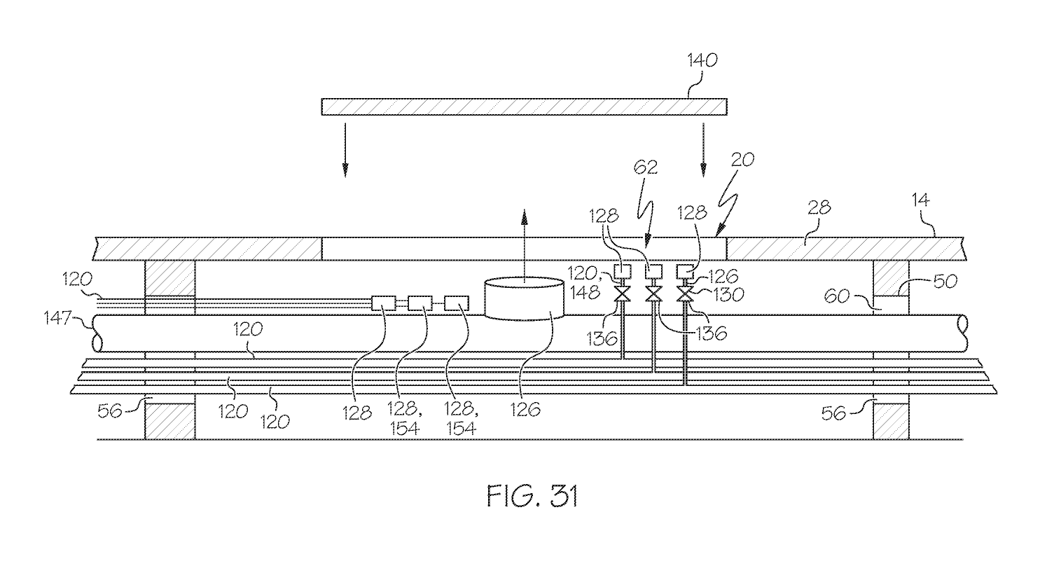

Referring to FIG. 39, another utility subsystems 198 of the connection box 22 can include or take the form of a smoke distribution subsystem 202 that is fluidly and removably coupleable to the smoke fluid distribution system 120/148 (FIGS. 31 and 32) at the connection locations 20. The smoke distribution subsystem 198/202 can have an outlet 188/219 configured to discharge smoke to the simulation space 116 or to be fluidly connected to some other space or conduit. The outlet 188/219 can also be removably connectable to a prop 24 for delivery artificial smoke to the prop 24. In one embodiment, the smoke distribution subsystem 202 includes a refillable reservoir 218 for storing smoke fluid, and in this case the smoke distribution subsystem 202 may not necessarily be required to be connected to a smoke distribution system 148.

The liquid or fluid smoke distributed/controlled by the smoke distribution subsystem 198/202 may need to be heated and/or combusted to generate an output of smoke that is entrained in air, which may be able to be accomplished by the smoke distribution subsystem 202. Alternatively, the smoke distribution subsystem 202 can distribute to a prop 24 or the like uncombusted smoke fluid that can be combusted by the prop 24. Further alternatively the smoke distribution system 148 and/or subsystem 202 can distribute smoke that is already entrained in air or readily entrained in air, and the distributed smoke does not need to be further treated (combusted) at the connection box 22, prop 24 or elsewhere.

Another one of the utility subsystems 198 can include or take the form of a drain line (not shown) having an outlet that can be removably coupleable to a connection 128 or branch 126 (or main line 124) of a drain utility distribution system 120 positioned at the connection location 20. In one case, a branch 126 of the drain line utility subsystem 120 can be fluidly coupled to a tray 25 via a hose 191 or the like. The drain utility subsystem 198 can include valves or the like that can be remotely controlled such that, for example, when a drain is opened fluid drains, by gravity, from the tray 25 into the drain line and is drained away from the connection box 22 and system 10. The drain utility distribution system 120 and/or subsystem 198 can thus include an inlet that is removably coupleable to a prop 24 or other device.

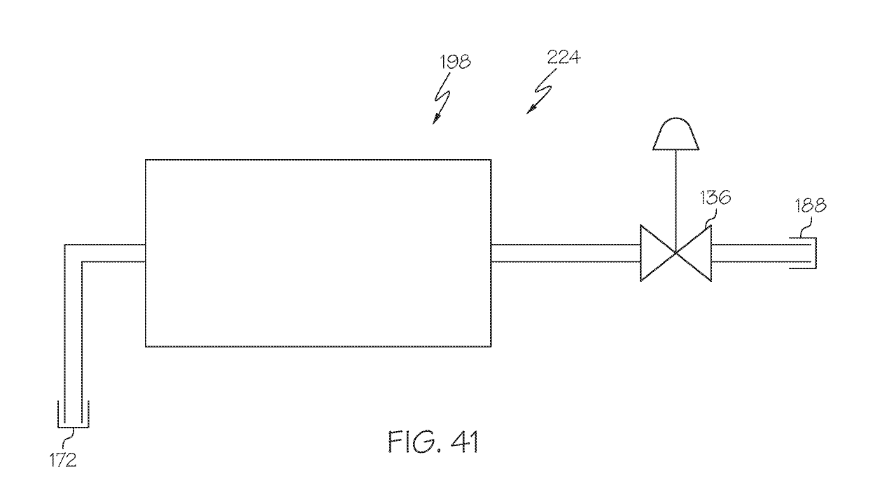

Referring to FIG. 41, another one of the utility subsystems 198can include or take the form of a water supply subsystem 224 which includes an inlet 172 removably coupleable to the water distribution system 120 at the connection locations 20, and an outlet 188 removably coupleable to the prop 24 or other device for delivery of water to the prop 24 or other device. The water utility subsystem 198 can also instead be coupled to a manually operable hose or other extinguishant device for delivering water or other extinguishants for training or safety purposes. The water supply subsystem 224 fluidly couples the water distribution system to the prop 24 for, for example, filling a fire tray of the prop 24 or supplying water to an extinguishing system of the prop 24. The water supply subsystem 224 can include one or more valves 136 that can operate in the same or a similar manner as described above in the context of the fuel gas utility subsystem 200, and which can be similarly controlled by the main controller 119 and/or subcontroller 221.

Each connection box 22 can include the subcontroller 221 (FIG. 35) which can be electrically and/or operatively coupled to the main controller 119 through, in one case, a connection to one or more of the utility distribution systems 120. The subcontroller 221 can be configured to receive and process inputs and provide outputs to control various components of the connection box 22 and, in some cases, external components connected thereto, such as a prop 24. For example, the main controller 119 and/or subcontroller 221 can be electrically or operatively coupled to the fuel gas utility subsystem 198/200 for controlling gas flow through the connection box 22 and/or to the prop 24. In this case, for example, the subcontroller 221 can be electrically or operatively coupled to the control valves 210 of the fuel gas utility subsystem 200 to control the flow of gas to a prop 24 or to shut off the flow of fuel gas in an emergency. Thus the controller 119 can be positioned in the technical room 104 to control distribution of a utility through at least one of the utility distribution systems 120 or the connection box 22. The controller 119 can be at least partially manually operable by a user positioned in the technical room 104.

Referring to FIG. 35, the connection box 22 can include an electrical box 220 containing the subcontroller 221 therein, along with an ignition system for a pilot burner 204, transformers, transformer circuits, data connections, or other electrical components. The electrical box 220 can have or be coupled to a plurality of input cables 191 for connecting the electrical box 220 to one or more data connection 152, power supply connection 154, or other electrical connections. Each of the input cables 191 are removably connectable to corresponding utility connections at the connection location 20, and/or to a prop 24 or other device.

The subcontroller 221 can be configured to receive data from the plurality of sensors and devices described herein and transmit the data, via connection to a data utility distribution system 120, to the main controller 119. The main controller 119 can process the data received from the subcontrollers 221 and send control signals to the subcontroller 221 in response to the data. Upon receiving the control signals from the main controller 119, the subcontroller 221 can relay the control signal to the one or more control devices, such as a control valve 210 in the fuel gas utility subsystem 198/200 or water supply subsystem 198/224.

The main controller 119 and/or subcontroller 221 can also, for example, be electrically or operatively coupled to the water supply subsystem 198/224, in particular control valves 136 in the water supply subsystem 224 for controlling a flow or supply of water. The main controller 119 and/or subcontroller 221 can be electrically or operatively coupled to the smoke distribution subsystem 198/202 for operation of the smoke generator. Thus it can be seen the main controller 119 and/or subcontroller 221 can be electrically and/or operatively connected to some or all of the utility distribution systems 120 and/or subsystems 198 to control such utility distributions systems 120 and/or subsystems 198, and the flow of utilities therethrough within the simulator 10 or in the connection box 22.

In some cases all or certain functions can be accomplished autonomously by a subcontroller 221 without communication to or from the main controller 119. For example, the subcontroller 221 may include or be able to access instructions in the form of software or the like, for starting up a prop 24 such that the prop 24 displays fire/frame, and activates the sensors or the prop 24 (if any) to be ready to receiving inputs. In this case, when a subcontroller 221 receives a command, such as from the main controller 119 or directly from a user, to initiate a startup sequence, the subcontroller 221 may proceed to execute a set of commands or operations, issue control signals to a plurality of control devices, receive data from a plurality of sensors, and change control signals in response to the data received from the sensors without having to receive instructions from the main controller 119. Additionally, each subcontroller 221 can include one or more control circuits capable of executing specific sequences of operations without receiving input from the main controller 119. As an example, the subcontroller 221 may include a circuit configured to automatically shut off the flow of fuel gas in response to a high temperature within the connection box 22.

The main controller 119 and/or subcontroller 221 can be electrically coupled to a pilot flame ignition system for initiating ignition fuel gas to so that the prop 24 exhibits a flame 95 (see FIGS. 1, 5 and 6). The main controller 119 and/or subcontroller 221 can be electrically coupled to a temperature sensor at the burner of the prop 24 for detecting the existence of a flame 95. The main controller 119 and/or subcontroller 221 and/or connection box 22 can be electrically or operatively coupled to a plurality of thermocouples or temperature sensors positioned within or outside of the connection box 22 (e.g., mounted to an exterior surface of the connection box 22 and/or positioned on the prop 24 or elsewhere inside or outside the simulation space 116). The temperature sensors can measure the temperature of the simulation space 116, temperature of the prop 24 for flame proving or extinguishing detection purposes, measure external temperatures, and/or measure an internal temperature of the connection box 22 to protect the electrical components of the connection box 22 from damage due to excessive heat. The output of the temperature sensors can be used by the main controller 119 and/or subcontroller 221 to determine whether high-temperature condition exists, and if so take appropriate actions (e.g., operate the gas shutoff valve or activate an extinguishing system).

The main controller 119 and/or subcontroller 221 and/or connection box 22 can also be electrically or operatively coupled to one or more gas detection heads for detecting fuel gas or other gases within or adjacent to the connection box 22, prop 24 or within the simulation space 116 and/or structure 12. The main controller 119 and/or subcontroller 221 and/or connection box 22 can also be electrically or operatively coupled to light fixtures within or outside of the connection box 22 and/or structure, and may also be electrically and/or operatively coupled to any of a wide range of other systems or devices for providing power to, sending control signals to, or receiving data from such systems or devices.

Although an actual flame/fire may be able to be created in the simulator 10, instead or in addition a screen, monitor, display, digital flame panel or the like, which displays a simulated hazardous condition (such as a flame, fire, smoke, etc.) can be used, as shown in FIG. 3. In this case the screen, monitor, display or the like can be connected to a utility distribution system 120, such as an electrical system to provide power thereto, and/or a communications system to control the screen, monitor or display or receive inputs therefrom (such as outputs from a sensor that detects a real or simulated extinguishant directed at the prop 24).

The main controller 119 and/or subcontroller 221 can be electrically coupled to one or more extinguishant sensors, temperature sensors and/or to a heater component positioned in the simulation space 116. For example an extinguishant sensor can be positioned at or adjacent to one or more, or each, prop 24 for detecting a real or simulated extinguishant agent directed at the prop 24. If the sensor/subcontroller 221 detects a real and/or simulated extinguishant, for example as controlled or directed by a user during a fire training simulation, and in some cases if proper firefighting technique is used, the subcontroller 221 and/or main controller 119 can reduce the flow of fuel gas to the prop 24 to reduce the size of the flames, or reduce the rate of growth of the flames. In the case of a simulated fire panel such as some of the props 24 shown in FIG. 3, the main controller 119 and/or subcontroller 221 may provide an output that causes the size of the displayed flame/fire to be reduced. Conversely, the lack of detection of an extinguishant, or detection of an extinguishant applied in an improper manner, can cause the subcontroller 221 and/or main controller 119 to increase the flow of fuel gas and/or the displayed flame. In cases where the prop 24 includes other output, such as a smoke and/or heat output, the props 24 can be controlled in a similar manner.

Referring to FIGS. 31, 32 and 35-37, a connection box 22 can be placed on, over or adjacent to one of the connection locations 20 in the floor 14 and each of the utility subsystems 198 of the connection box 22 can be removably connected to the utility distribution systems 120 at the connection location 20. In one embodiment the connection box 22 is positionable in any rotational orientation relative to the connection location 20.

Referring to FIG. 3, the connection box 22 can be moved to or between any of the connection locations 20 shown therein by disconnecting all utility subsystems 198 of the connection box 22 from the utility distribution systems 120 (e.g. by disconnecting all inlets 172) at one connection location 20. The connection box 22 can then be decoupled from all props 24 or other devices (e.g. by disconnecting all outlets 188). The connection box 22 can then be moved to the other different connection location 20, and the utility subsystems 198 are connected to the utility distribution systems 120 via inlets 172. A cover 140 can then be placed over the previous connection location 20. The props 24 or other device from the original location, and/or other props 24/devices, can then be operatively to the connection box 22 at the new connection location 20 via the outlets 188. The props/devices are thereby connected to the utility distributions systems 120, subcontroller 221 and/or main controller 119 as desired.

Additionally, a plurality of connection boxes 22 can be simultaneously utilized in the fire training simulator 10 by installing each connection box 22 at a different connection location 20. By using multiple connection boxes 22 and props 24 and/or by changing the location of the connection boxes 22 and props 24 within the simulation space 116 of the fire training simulator 10, multiple additional training scenarios can be further provided using the fire training simulator 10.

Referring to FIG. 3, the simulator 10 can include a safety system 230 comprising a safety network 120/158 that is operatively coupled to a safety controller 118. The safety network 158 can include or taking the form of a cabling/wire/communication network, which is connectable to one or more manually operable switches or e-stops 232 mounted to a wall panel 16. In one case the safety network 158 is the same things, or a part of, the utility distribution system 120 that provides communication to the main controller 119. However if desired the safety network 158 can be its own, stand-alone network that provides redundancy, or in some cases is more robust.

The safety network 158 can also include or be operatively coupled to gas detection sensors 234 and/or temperature sensors 236 spaced about the structure 12/simulation space 116. The e-stop 232 may be a manually actuable, such as by a stop push button, switch, lever, or other user input device, and the e-stop 232 can be operatively connectable to the main controller 119, subcontroller 221, and/or safety controller 118 to send a signal to shut off the system using one or more shutoff devices or communication systems 114 (FIG. 5), such as an automated shutoff valve. When the e-stop 232 is actuated, the controller 119, safety controller 118, and/or subcontroller 221 can thereby automatically initiate various safety protocols, such as terminating the flow of fuel and/or smoke, initiating fire extinguishant systems such as sprinklers, opening ventilation channels, opening doors and windows, opening drains, circulating cooling air, etc.

The gas detection sensor 234 can measure the concentration of fuel gas within the simulation space 116 of the simulator 10. When a fuel gas concentration as sensed by the gas detection sensor 234 is determined to be unsafe and/or when the gas detection sensor 234 detects other gases such as oxygen, carbon dioxide, or the like to detect an unsafe condition, safety steps, such as those mentioned above implemented when the e-stop 232 is triggered, can be implemented. The temperature sensor 236 can be positioned to measure the temperature inside of the simulation space 116 and can be used to determine a high temperature condition therein, and trigger the same or similar safety protocols.

The safety network 158 transmits data from the safety system or e-stop 230, gas detection sensor 234, and temperature sensor 236 to the main controller 119 and/or safety controller 118 in the technical room 104. In some cases, the safety system 230 may include a separate safety controller 118 electrically coupled to the safety network 158 and any desired control devices, such as gas shutoff valves, extinguishing systems, or the like. The main controller 119 and/or safety controller 118, upon receiving data from the e-stop 232, gas detection sensor 234, and/or temperature sensor 236 and/or other sensors indicating an unsafe condition can send a control signal to one or more of the gas shutoff valve, extinguishing system, flash over system, or other system to immediately stop the generation of live fire within the simulation space 116 (e.g. by terminating the flow of fuel and/or increasing the level of water in a water tray 25) and implement safety steps, such as those outlined above. The main controller 119 and/or safety controller 118 can also activate one or more visual or auditory alarms, ventilation systems, or other output devices in response to the unsafe condition and/or send a notification to emergency personnel.

The e-stop 232, gas detection head/sensor 234, and/or temperature sensor 236 can each be positioned on the inner surface 88 of one of the wall panels 16. The e-stop 232, gas detector 234, and/or temperature sensor 236 can be electrically removably coupled to the safety network 158 by wires or cable. The safety network 158 can run along the channel 60 in the floor 14 to the main controller 119 or a separate safety controller 118. The wall panel 16 having the e-stop 232, gas sensor 234, and/or temperature sensor 236 can be disconnected from the safety network 158, such as by unplugging associated electrical connections and uncoupling the wall panel 16 from the floor 14 and roof 18. The wall panel 16 with the e-stop can then be moved to another location, recoupled to the floor 14 and roof 18, and then reconnected to the safety network 158. In this manner, at least one of the wall panels 16 can be considered a “dedicated” safety control wall panel 16, and the position of the safety system components 232, 234, 236 can be moved between different locations within the simulation space 116 by moving the dedicated safety control wall panel 16. In one embodiment, the e-stop input device 232 can be positioned in a wall panel 16 having a door 86, and the wiring for the e-stop 232 can be routed through the door casing from the e-stop 232 to the connection point in the floor 14.

Although the invention is shown and described with respect to certain embodiments, it is obvious that modifications will occur to those skilled in the art upon reading and understanding the specification, and the present invention includes all such modifications.

1. A training system comprising:
a floor structure;
a utility distribution system generally positioned in or below said floor structure, said utility distribution system including a plurality of connection locations spaced about said floor structure; and
a utility connection box removably fluidly connectable to the utility distribution system at each of the plurality of connection locations, wherein the utility connection box is removably fluidly connectable to an external line or device to thereby fluidly connect the external line or device to the utility distribution system.

2. The system of claim 1 wherein the utility connection box includes an inlet removably fluidly connectable to the utility distribution system at one of the connection locations and an outlet in fluid communication with the inlet and removably fluidly connectable to the external line or device.

3. The system of claim 1 further comprising a plurality of modular wall panels that are removably attachable to the floor structure in a variety of configurations to thereby define a training space, wherein said training space is sized such that a human trainee is positionable therein.

4. The system of claim 3 wherein the wall panels are directly or indirectly removably attachable to each other.

5. The system of claim 3 wherein at least one of said wall panels includes a window opening and at least another one of said wall panels includes a door opening.

6. The system of claim 3 wherein the plurality of wall panels includes a plurality of external wall panels configured to extend around an outer perimeter of the floor structure and a plurality of internal wall panels configured to be positioned on said floor structure and at least partially spaced away from said outer perimeter.

7. The system of claim 3 further comprising a plurality of roof panels removably coupleable to said wall panels and to each other to thereby form a generally enclosed structure with said plurality of wall panels and said floor structure.

8. The system of claim 1 wherein the utility distribution system is at least one of a fuel distribution system, a water distribution system, an air distribution system, a fluid drain system, or a smoke fluid distribution system.

9. The system of claim 1 wherein said utility distribution system includes an electrical portion configured to distribute at least one of electrical power or electrical signals, and wherein the connection box includes an electrical inlet that is removably electrically connectable to said electrical portion of said utility distribution system, and wherein said connection box includes an electrical outlet in electrical connection with said electrical inlet, and wherein said outlet is removably electrically connectable to an external electrical line or device to thereby electrically connect said external electrical line or device to said electrical portion of said utility distribution system.

10. The system of claim 1 wherein the utility distribution system is a fuel distribution system, and wherein the system includes a prop removably fluidly coupleable to the connection box and configured to emit a flame fueled with fuel from said fuel distribution system.

11. The system of claim 1 wherein said connection box is connectable to each of the plurality of connection locations in a position where the connection box is generally positioned above the floor structure.

12. The system of claim 1 wherein the connection box is removably attachable to the floor structure.

13. The system of claim 1 wherein each connection location is at least partially defined by an opening in said floor structure, wherein the opening is configured to provide manual access to said utility distribution system by a person supported on said floor structure.

14. The system of claim 1 wherein said floor structure is generally flat and planar, and lacks any components permanently coupled thereto that protrude upwardly from said floor structure.

15. The system of claim 1 wherein said floor structure has a length and a width dimension generally corresponding to a standard sea transport or intermodal container.

16. The system of claim 1 wherein said floor structure includes a generally flat upper surface and support structure positioned below said upper surface, wherein said support structure includes a plurality of channels formed therein and extending parallel to said upper surface, and wherein at least part of said utility distribution system is positioned in said channels.

17. The system of claim 1 wherein the connection box further includes a remotely controllable fluid control subsystem configured to control a flow of a utility of the utility distribution system therethrough.

18. The system of claim 1 further comprising a generally closed control room positioned on said floor structure and generally isolated from a main compartment of said training system, and wherein the system further includes a controller configured to control distribution of a utility through at least one of said utility distribution system or said connection box, and wherein said controller is at least partially manually operable by a user positioned in said control room.

19. The system of claim 1 wherein each of said plurality of connection locations includes an access opening providing fluid communication to the utility distribution system.

20. The system of claim 1 wherein each connection location provides access to an internal volume of said utility distribution system.

21. The system of claim 1 wherein the connection box is moveable between and removably connectable to each of the plurality of connection locations.

22. A training system comprising:
a structure including:
a floor; and
a utility distribution system generally positioned in or below said floor, said utility distribution system having a plurality of spaced apart connection locations; and
a utility connection box removably connectable to the utility distribution system at each of the plurality of connection locations, wherein the utility connection box is removably connectable to an external line or device to thereby connect the external line or device to the utility distribution system, and wherein the connection box is moveable between and removably connectable to each of the plurality of connection locations.

23. The system of claim 22 further comprising a plurality of modular wall panels that are removably attachable to the floor in a variety of configurations to thereby define a training space, wherein said training space is sized such that a human trainee is positionable therein.

24. A system comprising:
a utility connection box including a housing and having, positioned within or coupled to the housing:
a fluid inlet removably fluidly connectable to a fluid distribution system;
a fluid outlet in fluid communication with the fluid inlet and removably fluidly connectable to an external fluid line or device to thereby fluidly connect the external line or device to the fluid distribution system;
an electrical inlet removably connectable to an electrical distribution system for distributing electrical power or electrical signals; and
an electrical outlet in communication with the electrical inlet and connectable to external electrical line or device to thereby electrically connect the external electrical line or device to the electrical distribution system.

25. The system of claim 24 wherein the connection box further includes a remotely controllable fluid control subsystem configured to control a flow of a utility of the fluid distribution system therethrough.

26. The system of claim 24 wherein the fluid distribution system is at least one of a fuel distribution system, a water distribution system, an air distribution system, a fluid drain system, or a smoke fluid distribution system.

27. The system of claim 24 further comprising a supplemental fluid inlet removably fluidly connectable to a supplemental fluid distribution system, and a supplemental fluid outlet in fluid communication with the supplemental fluid inlet and removably fluidly connectable to an supplemental external fluid line or device to thereby fluidly connect the supplemental external fluid line or device to the supplemental fluid distribution system, and wherein the supplemental fluid inlet and the supplemental fluid outlet are both positioned within or coupled to the housing.

28. (canceled)

29. (canceled)

30. The system of claim 28 wherein said connection box is connectable to each of the plurality of connection locations in in a position where the connection box is generally positioned on or above the floor structure, and wherein each connection location is at least partially defined by an opening in said floor structure.

31. The system of claim 24 wherein the fluid distribution system is a fuel distribution system, and wherein the external fluid line or device includes a prop removably fluidly coupleable to the connection box and configured to emit a flame fueled with fuel from said fuel distribution system.

32. (canceled)
